(19) United States
(12) Patent Application Publication
(10) Pub. No.: US 2016/0241795 A1
(43) Pub. Date: Aug. 18, 2016

(54) IMAGE-CAPTURING DEVICE, RADIATION DETECTION APPARATUS, AND CONTROL METHOD FOR IMAGE-CAPTURING DEVICE

(71) Applicant: SONY CORPORATION, Tokyo (JP)

(72) Inventor: Toshiyuki NISHIHARA, Kanagawa (JP)

(21) Appl. No.: 15/025,944

(22) PCT Filed: Sep. 2, 2014
(86) PCT No.: PCT/JP2014/004502

§ 371 Date: Mar. 30, 2016

(30) Foreign Application Priority Data
Oct. 10, 2013 (JP) 2013-212612

(51) Int. Cl. H04N 5/32; G01T 7/00; G01T 1/20; H04N 5/374; H04N 5/353

(52) U.S. Cl. CPC H04N 5/32; H04N 5/3742; H04N 5/353; G01T 1/20; G01T 7/005

(57) ABSTRACT

A photoelectric conversion element converts light into electrical charge and accumulates the electrical charge. A floating diffusion region generates a voltage according to an amount of electrical charge transferred from the photoelectric conversion element. A floating diffusion region reset transistor initializes the generated voltage. A conversion unit performs conversion processing for converting the voltage into a digital signal. The photoelectric conversion element reset transistor initializes the amount of electrical charge accumulated in the photoelectric conversion element at a predetermined point in time after the voltage is initialized. The transfer transistor performs the transfer from the photoelectric conversion element to the floating diffusion region when an exposure time, which is shorter than the time required for the conversion processing, has elapsed from the predetermined point in time.

### TECHNICAL FIELD

The present technique relates to an image-capturing device, a radiation detection apparatus, and a control method for the image-capturing device. More particularly, the present technique relates to an image-capturing device, a radiation detection apparatus, and a control method for the image-capturing device configured to detect weak light.

### BACKGROUND ART

In recent years, medical diagnosis devices using SPECT (Single Photon Emission Computed Tomography, i.e., gamma camera) and PET (Positron Emission Tomography) have been widely introduced. In such photon counting of radiation based on SPECT and PET, a detection apparatus is required to have a higher temporal resolution, and at the same time, the detection apparatus is required to detect energy strength of each photon of radiation, and carry out filtering of counting in accordance with the energy strength.

For example, a tiny amount of gamma-ray source such as technetium is introduced into the body, and the in-vivo distribution of the gamma-ray source is derived from position information of radiated gamma ray, so that the blood flow state in the body and associated diseases such as ischemic symptom are diagnosed. In this detection, a configuration using a SPECT (gamma camera) device and using a scintillator and a photomultiplier tube in the SPECT device has been suggested (e.g., see PTL 1). A SPECT device that detects not only the incident position of the gamma ray but also the energy strength of the gamma ray has been suggested (e.g., see PTL 2).

Overview of the gamma ray detection in the SPECT device will be explained. This

SPECT device includes a collimator, a scintillator, a photomultiplier tube, a conversion device, and a calculation device. When the gamma ray generated from the gamma-ray source in the body passes through the collimator and enters the scintillator, the scintillator emits fluorescence, and the photomultiplier tube arranged in the array form detects the light thereof. The photomultiplier tube amplifies the light and emits electric current pulse, and these electric current pulses pass through a conversion device including a voltage conversion device, an amplifier, and an AD converter and are output to a calculation device as incidence light quantity values to each optical detection element.

On the other hand, the gamma ray attenuated by Compton scattering in the body may pass through the collimator and may be detected. This signal is noise that has lost its original position information. There may also be a noise that is emitted as an extremely high signal due to cosmic radiation. The SPECT device filters these noises using energy discrimination from the primary gamma ray that is not affected by scattering. The calculation device discriminates noise of each gamma ray and determines the position based on outputs given by the conversion device connected to each photomultiplier tube. When the scintillator is made of a single plate, the light emission thereof is detected by multiple photomultiplier tubes at a time. For example, the calculation device identifies the energy of the gamma ray from the summation of the outputs and identifies the incident position of the gamma ray from the barycenter of the outputs. In order to determine each gamma ray incidence as an independent event, these works need to be done in an extremely high speed. The number of events of the gamma rays that are determined to be primary (i.e., not noise) as described above is counted, and the in-vivo distribution of the gamma-ray source is identified.

The photon counting of radiation based on the energy discrimination explained above is capable of filtering scattered radiation which has lost position information to become noise, and can provide a high image-capturing contrast, and therefore, the photon counting of radiation based on the energy discrimination is also employed for transmission image-capturing of X ray in recent years, and the effects thereof are being recognized. An apparatus using the photon counting for capturing a transmission image of X-ray has been suggested (e.g., see PTL 3 and PTL 4), and they are expected to be applied to mammography and X-ray CT (Computed Tomography).

On the other hand, the inventor of the present application has proposed a new image-capturing device based on photon counting that increases the dynamic range by using time division and area division based on multiple pixels (e.g., see PTL 5). This image-capturing device is built upon the circuit configuration of the CMOS (Complementary Metal-Oxide Semiconductor) imager. Such device can also be used as a photon counting device in which the entire pixel array in the chip is adopted as a single light receiving surface.

### CITATION LIST

### Patent Literature

PTL 1: JP 2006-242958 A

PTL 2: JP 2006-508344 W

PTL 3: JP 2011-24773 A

PTL 4: JP 2004-77132 A

PTL 5: JP 2011-97581 A

### SUMMARY

### Technical Problem

However, it is difficult for the above device to correctly detect the number of photons. First, as described in PTL 1 to PTL 5, it is assumed that radiation is counted using a combination of a scintillation and a semiconductor photon counter using a semiconductor CMOS imager or a structure similar thereto. When light is detected using such structure, the temporal resolution of the light detection is determined by a frame rate. This frame rate is determined by the circuit performance that is required to read and output all the effective pixels, and the frame rate is usually in the order of several milliseconds to several dozen milliseconds.

For example, in the gamma camera, the number of radiations entering the light reception unit per one square millimeter is 100 or less per second. But in the mammography, the number of radiations entering is several tens of thousands to several million per second. In the CT image-capturing, the number of radiations entering is higher by an order of magnitude. In order to count all of them, it is necessary to complete the cycle of the detection and the determination in the order of several microseconds or nanoseconds. Therefore, when the radiation photon counting is applied to the mammography and the CT image-capturing, there is a problem in that the temporal resolution may be insufficient.

In this case, a COMOS imager having pixels in an array of 64 rows by 64 columns is considered. This CMOS imager further includes a detection determination circuit, a register, and an output circuit. In the CMOS imager, the incident light detected by each pixel is accumulated in a pixel as electrical charge that is photoelectrically converted. The detection determination circuit is provided for each row. Each detection determination circuit has, for example, an AD (Analog to Digital) conversion device, and each AD conversion device is connected to 64 pixels in a row. When a pixel output is read by a detection circuit, any given row is selected, and outputs from the 64 pixels are read by 64 detection circuits in parallel and are converted from analog to digital, and presence/absence of photon is determined in terms of digital. The output result of each pixel that is detected and determined is temporarily saved in a register, and is transferred to an output circuit in a reading period for a subsequent row, and is output as digital data.

Each row is read in order and in a circulating manner, and when the reading is done for 64 times, the series of reading is completed. When the accumulated electrical charge is transferred for reading, the photodiode is reset, and therefore, an exposure time and an accumulation period for photoelectrically converted electrical charge are provided from when a certain frame is read to when a subsequent frame is read.

Suppose that the CMOS imager explained above is used as a light reception device having a single light reception surface instead of the photomultiplier tube explained above. For example, suppose that light diffusion means is provided on the front surface of each imager, so that the fluorescence from the scintillator enters the imager in a substantially uniform manner.

When the X-ray enters the scintillator at a time T2_1 within the exposure time in the X-th row of any given frame, the fluorescence emitted at that moment is received at a time by all the pixels, and is output in order in accordance with reading of each row. Then, in the period before all the effective rows had been read, a significant output D2_1 is continuously output. Further, when the subsequent X-ray enters the scintillator at a time T2_2 within the exposure time in the Y-th row of the subsequent frame, an output D2_2 is generated in a similar manner.

For example, suppose that it takes five microseconds to read each row of the CMOS imager, then, it takes 320 microseconds to read all the 64 rows, during which period the outputs D2_1 and D2_2 are generated continuously. In this case, if X-ray enters the scintillator with an interval shorter than 320 microseconds, the outputs of D2_1 and D2_2 are mixed, and this makes it impossible to neither determine the energy of the X-ray nor count the photons. More specifically, the temporal resolution of the imager is determined by so-called frame rate. At the frame rate, the temporal resolution is insufficient when counting the photons as explained above, and this makes it difficult to improve the accuracy of the photon counting.

The present technique is made in view of such circumstances, and it is an object of the present technique to provide a technique for allowing an image-capturing device to achieve exposure in an extremely short period of time.

### Solution to Problem

According to an embodiment of the present technique, there is provided an image-capturing device and a control method thereof, the image-capturing device includes: a photoelectric conversion element configured to convert light into electrical charge and accumulate the electrical charge; a floating diffusion region configured to generate a voltage according to an amount of electrical charge transferred from the photoelectric conversion element; a floating diffusion region reset transistor configured to initialize the generated voltage; a conversion unit configured to perform conversion processing for converting the voltage into a digital signal; a photoelectric conversion element reset transistor configured to initialize the amount of electrical charge accumulated in the photoelectric conversion element at a predetermined point in time after the voltage is initialized; and a transfer transistor configured to perform the transfer from the photoelectric conversion element to the floating diffusion region when an exposure time, which is shorter than the time required for the conversion processing, has elapsed from the predetermined point in time. Accordingly, this produces the effect that the transfer from the photoelectric conversion element to the floating diffusion region is performed when the exposure time, which is shorter than the time required for the conversion processing, has elapsed from the predetermined point in time.

According to the first embodiment, the image-capturing device may include a pixel array unit including a plurality of pixels each having the photoelectric conversion element, the floating diffusion region, the floating diffusion region reset transistor, the photoelectric conversion element transistor, and the transfer transistor, wherein the pixel array unit may be divided into a plurality of areas, and the conversion unit may be configured to output the converted digital signal for each of the areas. Accordingly, this produces the effect that the digital signals are output for each region.

According to the first embodiment, the image-capturing device may further include:

a holding unit configured to provide a noise component holding unit, for each of the areas, configured to hold a digital signal converted from the initialized voltage as a noise component; and a noise elimination unit configured to perform noise elimination processing for eliminating the held noise component from the digital signal converted from the voltage when the transfer is performed, wherein the photoelectric conversion element reset transistor may initialize the amounts of electrical charge in all of the areas at the predetermined point in time, the transfer transistor may perform the transfer in all of the areas when the exposure time has passed from the predetermined point in time, and the conversion unit may perform the conversion processing on each of the initialized voltage and the voltage when the transfer is performed, thus converting, into the digital signal, each of the initialized voltage and the voltage when the transfer is performed. Accordingly, this produces the effect that the transfer is performed in all of the areas when the exposure time has elapsed from the predetermined point in time.

According to the first embodiment, the image-capturing device may further include:

a noise component holding unit configured to hold a digital signal converted from the initialized voltage as a noise component of any of the areas; and a noise elimination unit configured to perform noise elimination processing for eliminating the held noise component from the digital signal converted from the voltage when the transfer is performed, wherein the photoelectric conversion element reset transistor may initialize the amount of electrical charge in any of the areas, and the transfer transistor may perform the transfer in any of the areas. Accordingly, this produces the effect that the amount of electrical charge is initialized in any of the areas, and the transfer is performed.

According to the first embodiment, the image-capturing device may include: a conversion unit arrangement substrate having the conversion unit arranged thereon; and a pixel arrangement substrate having the photoelectric conversion element, the floating diffusion region reset transistor, the photoelectric conversion element transistor, and the transfer transistor which are arranged thereon, wherein the pixel arrangement substrate may be stacked on the conversion unit arrangement substrate. Accordingly, this produces the effect that the pixels are arranged on the pixel arrangement substrate stacked on the conversion unit arrangement substrate having the conversion unit arranged thereon.

According to a second embodiment of the present technique, a radiation detection apparatus includes: a scintillator configured to generate light when radiation has entered; a photoelectric conversion element configured to convert light into electrical charge and accumulate the electrical charge; a floating diffusion region configured to generate a voltage according to the amount of electrical charge transferred from the photoelectric conversion element; a floating diffusion region reset transistor configured to initialize the generated voltage; a conversion unit configured to perform conversion processing for converting the voltage into a digital signal; a photoelectric conversion element reset transistor configured to initialize the amount of electrical charge accumulated in the photoelectric conversion element at a predetermined point in time after the voltage is initialized; a transfer transistor configured to perform the transfer from the photoelectric conversion element to the floating diffusion region when an exposure time, which is shorter than the time required for the conversion processing, has elapsed from the predetermined point in time; and a radiation detection unit configured to detect whether radiation has entered within an exposure time based on a digital signal from which the noise is eliminated. Accordingly, this produces the effect that the transfer from the photoelectric conversion element to the floating diffusion region is performed when the exposure time, which is shorter than the time required for the conversion processing, has elapsed from the predetermined point in time.

According to the second embodiment, the radiation detection apparatus may include a plurality of image-capturing devices arranged with a plurality of pixels each having the photoelectric conversion element, the floating diffusion region, the floating diffusion region reset transistor, the conversion unit, the photoelectric conversion element transistor, and the transfer transistor, and the detection unit may be configured to detect whether the radiation has entered for each of the image-capturing devices. Accordingly, this produces the effect that whether the radiation has entered is detected for each image-capturing device.

According to the second embodiment, the radiation detection unit may derive a frequency of detection of radiation from a number of detections of radiation within a certain period of time, and when the frequency of the detection of the radiation is more than a predetermined frequency, the photoelectric conversion element transistor may initialize the amount of electrical charge at the predetermined point in time after the voltage is initialized, and when the predetermined frequency is more than the frequency of the detection, the photoelectric conversion element transistor may initialize the amount of electrical charge before the voltage is initialized. Accordingly, this produces the effect that when the frequency of the detection of the radiation is more than the predetermined frequency, the amount of electrical charge is initialized at the predetermined point in time after the voltage is initialized, and when the predetermined frequency is more than the frequency of the detection, the amount of electrical charge is initialized before the voltage is initialized.

According to the second embodiment, when the frequency of the detection of the radiation is more than the predetermined frequency, the transfer transistor may perform the transfer when an exposure time, which is shorter than the time required for the conversion processing, has elapsed from the predetermined point in time, and when the predetermined frequency is more than the frequency of the detection, the transfer transistor may perform the transfer when the time required for the conversion processing has at least elapsed from the predetermined point in time. Accordingly, this produces the effect that when the frequency of the detection of the radiation is more than the predetermined frequency, the transfer is performed when the exposure time, which is shorter than the time required for the conversion processing, has elapsed from the predetermined point in time, and when the predetermined frequency is more than the frequency of the detection, the transfer is performed when the time required for the conversion processing has at least elapsed from the predetermined point in time.

According to an embodiment of the present technique, there is provided an image-capturing device including a photoelectric conversion element configured to convert light into electrical charge and accumulate the electrical charge; a floating diffusion region configured to generate a voltage according to an amount of electrical charge transferred from the photoelectric conversion element; a photoelectric conversion element reset transistor configured to initialize an amount of electrical charge accumulated in the photoelectric conversion element; and a transfer transistor configured to transfer the accumulated electric charge from the photoelectric conversion element to the floating diffusion region during an exposure time, wherein a start of the exposure time corresponds to a transition of the photoelectric conversion element reset transistor from a first state to a second state.

According to another embodiment of the present technique, there is provided a radiation detection apparatus including a scintillator configured to generate light when radiation enters the scintillator; a photoelectric conversion element configured to convert light into electrical charge and accumulate the electrical charge; a floating diffusion region configured to generate a voltage according to the amount of electrical charge transferred from the photoelectric conversion element; a photoelectric conversion element reset transistor configured to initialize an amount of electrical charge accumulated in the photoelectric conversion element; a transfer transistor configured to transfer the accumulated electric charge from the photoelectric conversion element to the floating diffusion region during an exposure time, wherein a start of the exposure time corresponds to a transition of the photoelectric conversion element reset transistor from a first state to a second state; and a radiation detection unit configured to detect whether radiation has entered within an exposure time based on a digital signal from which noise has been eliminated.

According to another embodiment of the present technique, there is provided a control method for an image-capturing device, including initializing a voltage generated by a floating diffusion region, wherein the floating diffusion region is configured to generate the voltage according to an amount of electrical charge transferred from a photoelectric conversion element configured to convert light into the electrical charge and accumulate the electrical charge; converting the voltage into a digital signal; causing a photoelectric conversion element reset transistor to initialize the amount of electrical charge accumulated in the photoelectric conversion element; and transferring the accumulated electric charge from the photoelectric conversion element to the floating diffusion region during an exposure time, wherein a start of the exposure time corresponds to a transition of the photoelectric conversion element reset transistor from a first state to a second state.

According to another embodiment of the present technique, there is provided a control method for a radiation detection apparatus, including initializing a voltage generated by a floating diffusion region, wherein the floating diffusion region is configured to generate a voltage according to an amount of electrical charge transferred from a photoelectric conversion element configured to convert light into the electrical charge and accumulate the electrical charge; converting the voltage into a digital signal; causing a photoelectric conversion element reset transistor to initialize the amount of electrical charge accumulated in the photoelectric conversion element; transferring the accumulated electric charge from the photoelectric conversion element to the floating diffusion region during an exposure time, wherein a start of the exposure time corresponds to a transition of the photoelectric conversion element reset transistor from a first state to a second state; and detecting whether radiation has entered within the exposure time based on a digital signal from which noise has been eliminated.

### Advantageous Effects of Invention

According to the present technique, an advantageous effect of reducing the exposure time of the image-capturing device can be achieved. It should be noted that the effects described here are not necessarily limited, and only any of the effects described in the present disclosure may be provided.

### BRIEF DESCRIPTION OF DRAWINGS

FIG. 1 is a block diagram illustrating an example of a configuration of a radiation detection apparatus according to a first embodiment.

FIG. 2 is a block diagram illustrating an example of a configuration of an image-capturing device according to the first embodiment.

FIG. 3 is a circuit diagram illustrating an example of a configuration of a pixel according to the first embodiment.

FIG. 4 is a timing chart illustrating an example of control of pixels according to the first embodiment.

FIG. 5 is a figure illustrating an example of a configuration of a pixel array unit and a detection circuit according to the first embodiment.

FIG. 6 is a flowchart illustrating an example of operation of a detection circuit according to the first embodiment.

FIG. 7 is a figure illustrating an example of exposure control when a two-dimensional image is obtained according to the first embodiment.

FIG. 8 is a figure illustrating an example of exposure control when light detection according to the first embodiment is performed.

FIG. 9 is a timing chart illustrating an example of control of pixels according to a first modification of the first embodiment.

FIG. 10 is a figure illustrating an example of exposure control when long exposure is performed according to the first modification of the first embodiment.

FIG. 11 is a figure illustrating an example of exposure control for selecting each section in order according to the first modification of the first embodiment.

FIG. 12 is a block diagram illustrating an example of a configuration of a radiation detection apparatus according to a second modification of the first embodiment.

FIG. 13 is a figure illustrating an example of a configuration of a detection circuit according to a second embodiment.

FIG. 14 is a timing chart illustrating an example of control of pixels according to the second embodiment.

FIG. 15 is a flowchart illustrating an example of operation of the image-capturing device according to the second embodiment.

FIG. 16 is a timing chart illustrating an example of control of pixels according to a modification of the second embodiment.

FIG. 17 is a perspective view illustrating an example of a configuration of a radiation detection apparatus according to the third embodiment.

FIG. 18 is a figure illustrating an example of a configuration of a pixel block according to the third embodiment.

FIG. 19 is a figure illustrating an example of a configuration of a detection block according to the third embodiment.

### DESCRIPTION OF EMBODIMENTS

Modes for carrying out the present technique (hereinafter referred to as embodiments) will be hereinafter explained. The explanation will be given in the following order.

1. First embodiment (example of exposure in exposure time shorter than sampling period)

2. Second embodiment (example of exposure in all the sections in exposure time shorter than sampling period all at a time)

3. Third embodiment (example of exposure in exposure time shorter than sampling period with stacked substrates)

### 1. First Embodiment

### “Example of Configuration of Semiconductor Light Detection Apparatus”

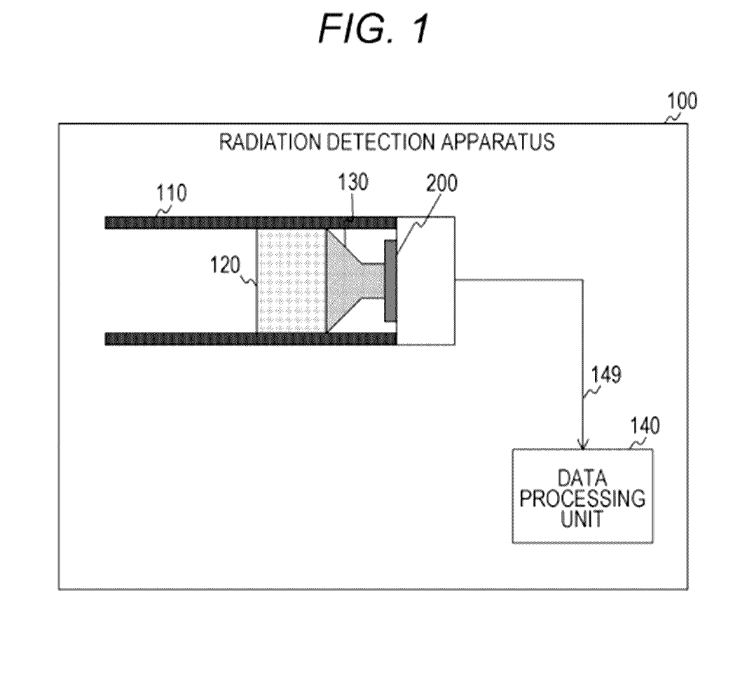

FIG. 1 is a block diagram illustrating an example of a configuration of a radiation detection apparatus 100 according to the first embodiment. This radiation detection apparatus 100 includes a collimator 110, a scintillator 120, an optical guide 130, an image-capturing device 200, and a data processing unit 140.

The collimator 110 is configured to pass only the radiation incident upon the image-capturing device 200 in a direction perpendicular thereto. This collimator 110 is made of, for example, lead. The radiation that has passed through the collimator 110 enters the scintillator 120.

The scintillator 120 receives the radiation that has passed through the collimator 110 and emits scintillation light. The optical guide 130 condenses the scintillation light and guides the scintillation light to the image-capturing device 200. This optical guide 130 also has a light homogenization function, and the scintillation light that is homogenized is emitted on the light receiving surface of the image-capturing device 200.

The image-capturing device 200 is configured to detect weak scintillation light. This image-capturing device 200 includes multiple pixels, and measures the light strength of the scintillation light for each pixel. The image-capturing device 200 provides the measurement result of the light strength, as digital data, to the data processing unit 140 via a signal line 149.

The data processing unit 140 determines the energy of the radiation based on each light strength result, and measures the number of times the significant data are generated, thus counting the photons of the radiation. It should be noted that the data processing unit 140 is an example of a radiation detection unit described in claims.

### “Example of Configuration of Image-Capturing Device”

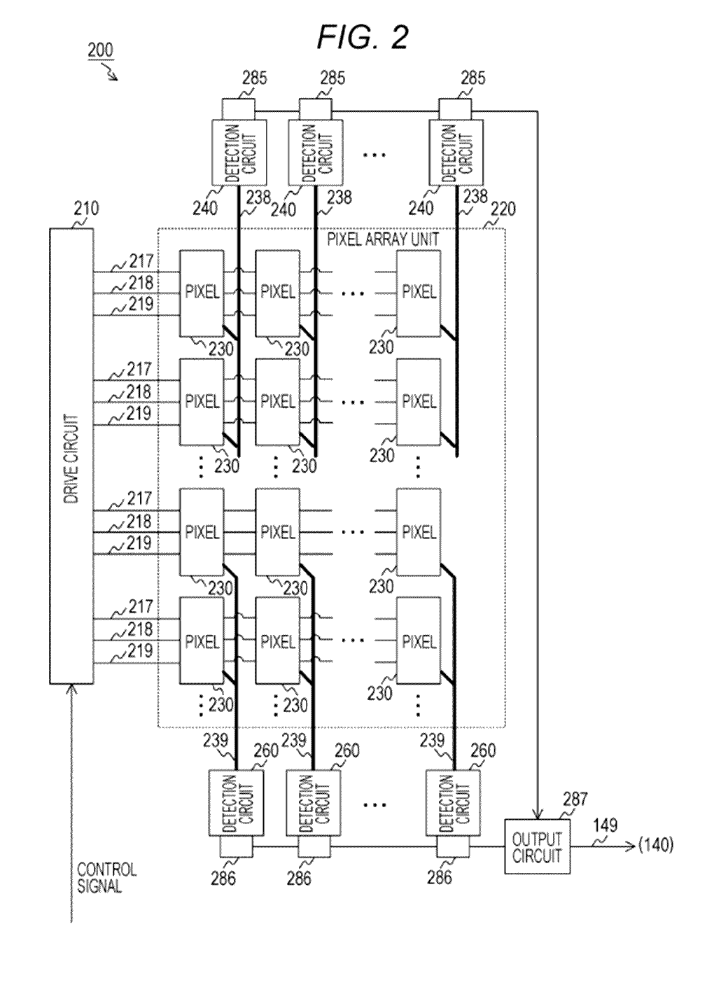

FIG. 2 is a block diagram illustrating an example of a configuration of the image-capturing device 200 according to the first embodiment. This image-capturing device 200 includes a drive circuit 210, a pixel array unit 220, detection circuits 240 and 260, registers 285 and 286, and an output circuit 287.

The pixel array unit 220 includes multiple pixels 230 arranged in a two dimensional lattice manner. In the pixel array unit 220, for example, the pixels 230 are arranged in 8 rows by 32 columns. In this case, the row means an arrangement of multiple pixels 230 arranged in any given direction in the pixel array unit 220, and the column means an arrangement of multiple pixels 230 arranged in a direction perpendicular to the row in the pixel array unit 220. The shapes of the pixels 230 are rectangular shape, and the ratio between the size in its row direction and the size in its column direction is about 1:4. Therefore, the shape of the pixel array unit 220 having these rectangular pixels 230 arranged in eight rows by 32 columns is substantially a square shape.

The pixel array unit 220 is divided into four sections. The first section is a section including two rows which are the first row and the fifth row. The second section is a section including two rows which are the second row and the sixth row. The third section is a section including two rows which are the third row and the seventh row. The fourth section is a section including two rows which are the fourth row and the eighth row. In two rows of each section, the exposure time is controlled by the drive circuit 210 at the same time, and the digital data are read by the detection circuits 240 and 260 at the same time. More specifically, each section is used as the unit of exposure control and reading process.

In this case, “exposure” does not mean guiding light to the image-capturing device 200 by mechanically opening and closing a shutter. The “exposure” means accumulating electrical charge converted from light by causing the drive circuit 210 to electronically control the pixels 230. Such exposure is called exposure using an electronic shutter. In the control of the exposure using the electronic shutter, the exposure is started by initializing the amount of electrical charge accumulated in a photoelectric conversion device, and the exposure is finished when the electrical charge is transferred from the photoelectric conversion device to the floating diffusion layer.

The pixel array unit 220 is divided into four sections in units of two rows, but the way for dividing the pixel array unit 220 is not limited thereto. For example, a number of rows other than two rows may be adopted as a section into which the pixel array unit 220 is divided, or a predetermined number of columns may be adopted as a section into which the pixel array unit 220 is divided.

The pixel 230 is configured to convert light into electrical charge, and generate a voltage according to the amount of electrical charge thereof. The scintillation light enters the pixel 230 as incident light in a direction perpendicular to the row direction and the column direction. The pixel 230 converts the incident light into electrical charge (photoelectric conversion), and generates a voltage according to the amount of electrical charge.

Each of the pixels 230 is connected via the signal lines 217, 218, and 219 to the drive circuit 210. In this case, the detection circuits 240 and 260 are provided for each column. In the first to the fourth rows, the pixels 230 in each column are connected to the detection circuit 240 corresponding to the column via a vertical signal line 238. On the other hand, in the fifth to the eighth rows, the pixels 230 in each column are connected to the detection circuit 260 corresponding to the column via a vertical signal line 239.

The drive circuit 210 selects the four sections in the pixel array unit 220 in order. This drive circuit 210 receives a control signal given from the outside of the image-capturing device 200. This control signal is a signal that is generated in response to user's operation. The control signal includes, for example, a setting signal for setting an exposure time and a command signal for commanding start and stop of photon counting. When the start of the photon counting is commanded, the drive circuit 210 selects the four sections in order, and causes the pixels 230 in a selected section to be exposed at the same time, and causes the pixels 230 to output the voltages according to the amount of exposure.

The detection circuit 240 is configured to detect the voltage according to the amount of electrical charge accumulated in the pixels 230. This detection circuit 240 uses a digital CDS (Correlated Double Sampling) circuit to convert the voltage according to the amount of exposure into a digital signal (i.e., sampling). Then, the detection circuit 240 determines presence/absence of incidence of a photon onto the pixel 230 based on the sampled voltage. The detection circuit 240 causes the determination result to be held in a register 285.

The registers 285 and 286 hold determination result about incidence of photon onto the pixel 230. The register 285 is provided for each detection circuit 240, and holds the detection result thereof. The register 286 is provided for each detection circuit 260, and holds the detection result thereof.

The output circuit 287 is configured to output the determination result held in the registers 285 and 286 as digital data in order.

### “Example of Configuration of pixels”

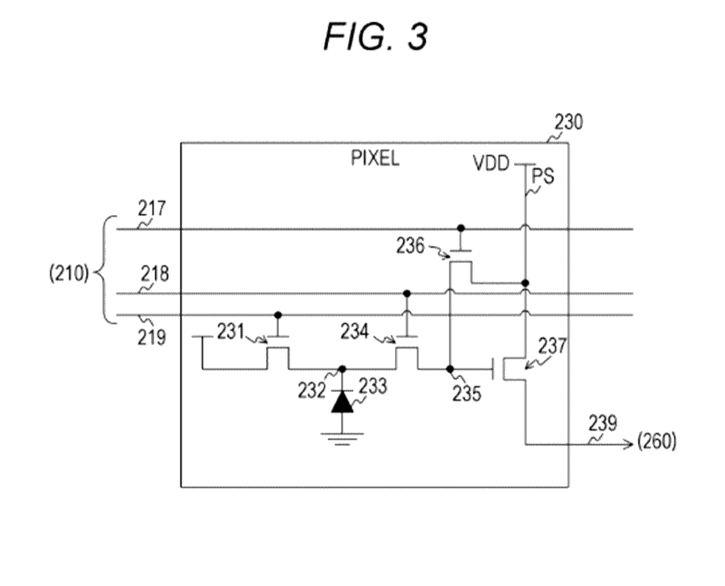

FIG. 3 is a circuit diagram illustrating an example of a configuration of the pixel 230 according to the first embodiment. This pixel 230 includes a PD reset transistor 231, nodes 232 and 235, a photodiode 233, a transfer transistor 234, an FD reset transistor 236, and an amplifier transistor 237. The transfer transistor 234, the FD reset transistor 236, and the amplifier transistor 237 are, for example, MOS (Metal-Oxide-Semiconductor) transistors.

The PD reset transistor 231 is a switching device for resetting the photodiode 233. “Resetting” the photodiode 233 means that the amount of electrical charge accumulated in the node 232 by the photodiode 233 is changed back to the initial value. The gate of the PD reset transistor is connected to the signal line 219, and the drain of the PD reset transistor is connected to the node 232. The PD reset transistor 231 is an example of photoelectric conversion device reset transistor described in claims.

The node 232 is configured to accumulate the photoelectrically converted electrical charge. The photodiode 233 is configured to convert the scintillation light into electrical charge and accumulates the electrical charge in the node 232. A pinned photodiode, which is a so-called HAD (Hole Accumulated Diode), is preferably used as a photodiode 233. The node 232 and the photodiode 233 are examples of photoelectric conversion devices described in claims.

The transfer transistor 234 is configured to transfer the photoelectrically converted electrical charge from the node 232 to the node 235. The gate of the transfer transistor 234 is connected to the signal line 218, and the source of the transfer transistor 234 is connected to the node 232, and the drain of the transfer transistor 234 is connected to the node 235.

The node 235 generates a voltage according to the amount of electrical charge accumulated by accumulating electrical charge that has been transferred. This node 235 is formed by a floating diffusion layer and the like.

The FD reset transistor 236 is configured to reset the floating diffusion layer. In this case, “resetting” the floating diffusion layer means that the voltage according to the amount of electrical charge is changed back to the initial value by changing the amount of electrical charge at the node 235 back to the initial value. The gate of the FD reset transistor 236 is connected to the signal line 217, and the source of the FD reset transistor 236 is connected to the power supply VDD, and the drain of the FD reset transistor 236 is connected to the node 235. It should be noted that the FD reset transistor 236 is an example of a floating diffusion layer reset transistor described in claims.

The amplifier transistor 237 is configured to amplify the voltage at the floating diffusion layer (node 235), and output a signal according to the amplified potential to the vertical signal line 239. The gate of the amplifier transistor 237 is connected to the node 235, and the source of the amplifier transistor 237 is connected to the power supply VDD, and the drain of the amplifier transistor 237 is connected to the vertical signal line 239. In this configuration, when the voltage of the floating diffusion layer is reset to the initial value, the amplifier transistor 237 outputs a voltage according to the initial value (hereinafter referred to as “reset level”) to the vertical signal line 239. When the electrical charge accumulated by the photodiode 233 is transferred to the node 235, the amplifier transistor 237 outputs an accumulation signal of a voltage according to the amount of electrical charge (hereinafter referred to as “signal level”) to the vertical signal line 239.

In this case, while the drive circuit 210 keeps the transfer transistor 234 in the OFF state, the drive circuit 210 controls the PD reset transistor 231 into the ON state, so that resetting of the photodiode 233 is started. Accordingly, all the electrical charge accumulated at the node 232 is drawn out by the power supply VDD. Then, the drive circuit 210 controls the PD reset transistor 231 into the OFF state, so that the resetting of the photodiode 233 is finished. The photodiode 233 is fully depleted due to the resetting, and immediately after the reset operation is completed, new electrical charge accumulation is started.

More specifically, the drive circuit 210 changes the PD reset transistor 231 from the ON state to the OFF state, and this causes the photodiode 233 to start exposure accumulation. Then, the drive circuit 210 controls the transfer transistor 234 into the ON state, and subsequently, the transfer transistor 234 is controlled into the OFF state, so that the exposure accumulation is terminated.

While the drive circuit 210 keeps the transfer transistor 234 in the OFF state, the drive circuit 210 controls the FD reset transistor 236 into the ON state, so that the resetting of the floating diffusion layer is started. Then, the drive circuit 210 controls the FD reset transistor 236 into the OFF state, so that the resetting of the floating diffusion layer is terminated. What should be noted here is that the potential of the floating diffusion layer in the reset completion state is not accurately at the power supply voltage, and the potential of the floating diffusion layer in the reset completion state includes kTC noise and feed-through in the OFF state. Further, the output signal that appears in the vertical signal line 239 includes offset of the amplifier transistor 237. This output signal (the reset signal and the accumulation signal) changes for every pixel 230 and on every resetting of the floating diffusion layer, and therefore, on every exposure operation of each pixel, the detection circuit 260 has to sample and save the output signal. The accumulation signal from which the kTC noise and the like are reduced is derived from a difference between this reset signal and the accumulation signal. The method for reducing the kTC noise and the like by detecting the difference between the reset signal and the accumulation signal as described above is called CDS (correlative double sampling).

By the way, some pixels other the pixels 230 are configured to turn on both of the FD reset transistor and the transfer transistor to draw the electrical charge accumulated in the photodiode. But in this configuration, when the transfer transistor is turned OFF after the electrical charge is drawn, the resetting of the photodiode is completed, and the exposure is started from that moment. On the other hand, the resetting of the floating diffusion layer and the detection of the voltage have to be carried out after that. Therefore, the exposure continues during the sampling period of the reset signal, and for this reason, the transfer and the detection of the accumulation signal is to be done at least after that. Therefore, in the configuration for starting the initialization of the amount of electrical charge by turning both of the FD reset transistor and the transfer transistor, it is difficult to extremely reduce the exposure time.

### “Example of Control of Pixels”

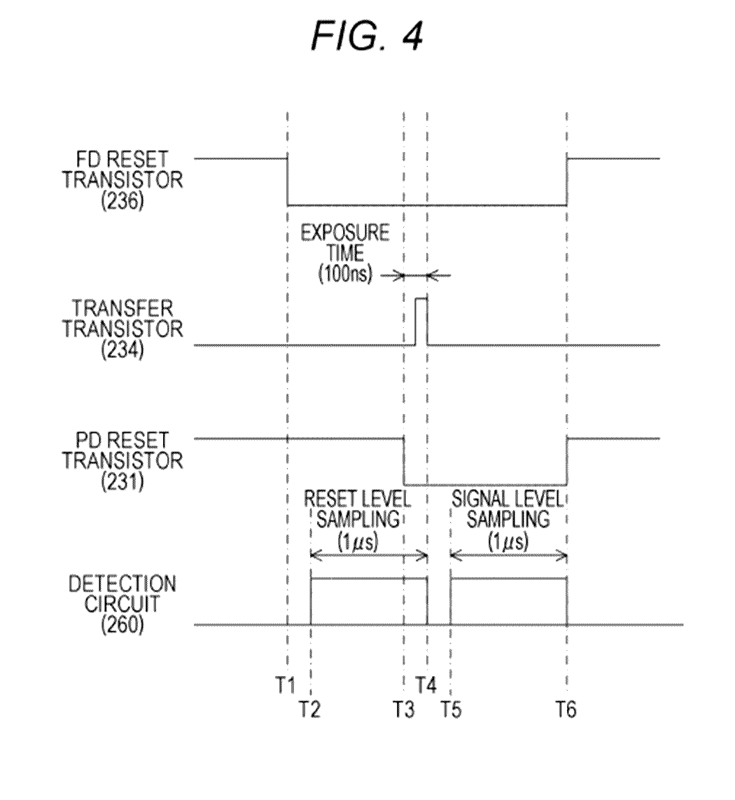

FIG. 4 is a timing chart illustrating an example of controls of the pixel 230 according to the first embodiment. In the initial state where no pixel is selected, the FD reset transistor 236 and the PD reset transistor 231 are considered to be in the ON state, and the transfer transistor 234 is considered to be in the OFF state. In the initial state, the PD reset transistor 231 is in the ON state, and therefore, the electrical charge in the photodiode 233 is all discharged. On the other hand, the FD reset transistor 236 is in the ON state, and therefore, the potential of the floating diffusion layer is initialized to substantially the power supply voltage (e.g., 3V).

Suppose that the drive circuit 210 selects a pixel at a time T1. First, the drive circuit 210 controls the FD reset transistor 236 into the OFF state. Accordingly, the potential of the floating diffusion layer attains the floating state, and the potential reflecting the potential of the floating diffusion layer is output from the vertical signal line 239.

At a time T2 when a certain period of time after the time T1 has elapsed, the detection circuit 260 starts sampling of the potential while the potential at that moment is adopted as the reset level. In this case, it takes a certain period of time (e.g., 100 nanoseconds) to stabilize the potential of the floating diffusion layer in the floating state, and after that period of time passes, the sampling is considered to be started. The sampling period which is required to sample the reset level is, for example, 1 microsecond (us). It should be noted that the sampling period for sampling the signal level is also considered to be the same.

Then, at a time T3 within the sampling period of the reset level, the drive circuit 210 controls the PD reset transistor 231 into the OFF state. Accordingly, the photodiode 233 is reset, and the exposure accumulation of the signal electrical charge is started, which means that the exposure is started.

Immediately before a time T4 at which the exposure time, which has been set in advance, passes from the time T3, the drive circuit 210 controls the transfer transistor 234 into the ON state, and transfers the signal electrical charge to the floating diffusion layer. Then, at a time T4 at which the exposure time has passed, the drive circuit 210 controls the transfer transistor 234 into the OFF state. Thus, the exposure is completed. In addition, at this time T4, the sampling of the reset level is completed.

In this case, the exposure time is considered to be set as a time shorter than the sampling period of the reset level and the signal level. When the sampling period is 1 microsecond (us), the exposure time is set as, for example, 100 nanoseconds (ns).

It should be noted that the drive circuit 210 is configured to start the exposure during the sampling period of the reset level, but the configuration is not limited thereto. The drive circuit 210 may start the exposure at the same time as the elapse of the sampling period of the reset level or after the sampling period elapses.

In this configuration, as soon as the exposure is finished, the sampling is finished. But the configuration is not limited thereto. The drive circuit 210 may start the exposure at a point in time at which the sampling is finished before the exposure is finished.

At a time T5 at which a certain period of time passes from the time T4 and when the potential of the floating diffusion layer is stabilized, the detection circuit 260 samples, as the signal level, the voltage according to the amount of signal electrical charge accumulated in the floating diffusion layer. Then, the detection circuit 260 derives the difference between the reset level and the signal level which have been saved, and outputs the signal of the voltage of the difference as an accumulation signal having reduced noise.

At a time T6 at which the sampling of the signal level is finished, the drive circuit 210 controls the PD reset transistor 231 into the ON state, so that all the electrical charge in the photodiode 233 is discharged. It should be noted that the drive circuit 210 may control the PD reset transistor 231 into the ON state after the sampling of the signal level is finished.

In the above control, the floating diffusion layer is reset before the exposure starts, and the sampling of the reset level is started. In the exposure time, the sampling of the reset level is not performed, and therefore, the exposure time is not required to be longer than the sampling period which is required for sample the reset level. This exposure time is determined by the control timing of the PD reset transistor 231 and the transfer transistor 234 and the time it takes to transfer the electrical charge from the photodiode 233 to the floating diffusion layer. For this reason, according to the control explained above, the exposure time can be reduced to several dozen nanoseconds (ns) or less.

In order to cause the detection circuit 260 to execute the CDS without problem, a dark electric current generated in the floating diffusion layer needs to be sufficiently small in the period from the sampling of the reset level to the sampling of the signal level. In general, the dark electric current of the floating diffusion layer is larger than the dark electric current of the photodiode 233 by an order of magnitude, and therefore, such CDS procedure is an extremely effective method in a short exposure.

### “Example of Configuration of Detection Circuit”

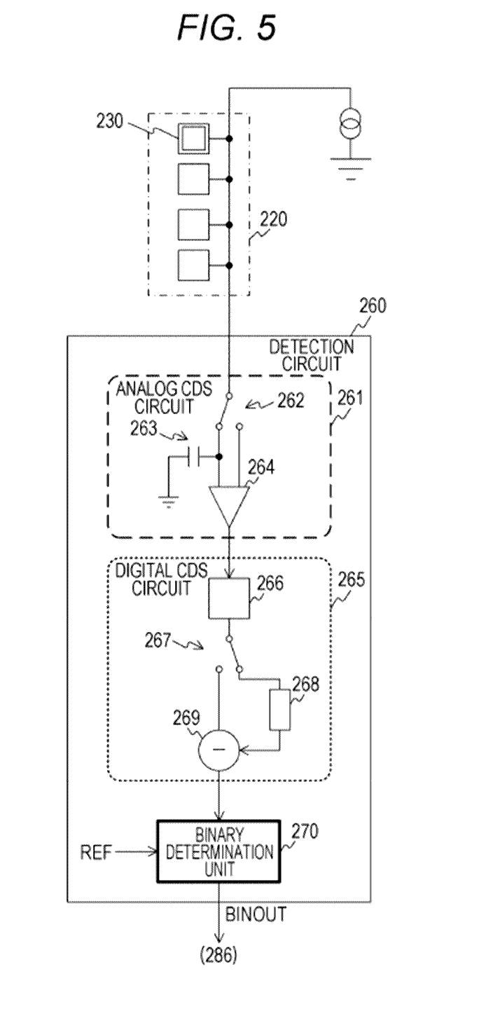

FIG. 5 is a figure illustrating an example of a configuration of the pixel array unit 220 and the detection circuit 260 according to the first embodiment. In the pixel array unit 220 described in the drawing, only four pixels 230 connected to a single detection circuit 260 are shown, and the other pixels 230 are not shown. This detection circuit 260 includes an analog CDS circuit 261, a digital CDS circuit 265, and a binary determination unit 270.

This analog CDS circuit 261 is configured to perform offset elimination using an analog CDS, and includes a switch 262, a capacitor 263, and a comparator 264.

The switch 262 is configured to switch the connection destination of the vertical signal line 239. This switch 262 includes a single input terminal and two output terminals. The input terminal is connected to the vertical signal line 239. One of the two output terminals is a terminal for outputting the reference voltage, and connected to one of the input terminals of the capacitor 263 and the comparator 264. The other of the two output terminals is a terminal for outputting a signal of a target of comparison with the reference voltage, and is connected to the other of the input terminals of the comparator 264.

When the reset signal of the pixel 230 is to be stored, the switch 262 connects the vertical signal line 239 to the terminal for outputting the reference voltage (the terminal to which the capacitor 263 is connected). When the result of the analog CDS is output by the comparator 264, the switch 262 connects the vertical signal line 239 to the terminal for outputting the signal of comparison target (the terminal to which the capacitor 263 is not connected).

The capacitor 263 is a holding capacitor for holding the reset signal of the pixel 311. The capacitor 263 is connected to one of the output terminals of the switch 262 and the comparator 264.

The comparator 264 is configured to output the difference between the signal held in the capacitor 263 and the signal of the comparison target. More specifically, the comparator 264 outputs the difference between the stored reset signal and the signal provided from the vertical signal line 239 (the accumulation signal or the reset signal). More specifically, the comparator 264 outputs the signal from which the noise generated by the pixel 230 such as kTC noise is eliminated. The comparator 264 is achieved with an operational amplifier of which gain is “1”, for example. The comparator 264 provides the signal of the difference to the digital CDS circuit 265. In this case, the signal of the difference between the reset signal and the reset signal will be referred to as no-signal, and the signal of the difference between the reset signal and the accumulation signal will be referred to as actual accumulation signal.

The digital CDS circuit 265 is configured to perform noise elimination using a digital

CDS, and includes an AD conversion unit 266, a switch 267, a register 268, and a subtraction device 269.

The AD conversion unit 266 is configured to convert the signal provided from the comparator 264 from analog into digital. It should be noted that the AD conversion unit 266 is an example of a conversion unit described in claims.

The switch 267 is configured to switch the supply destination of the AD-converted signal generated by the AD conversion unit 266. This switch 267 includes a single input terminal and two output terminals. The input terminal is connected to the comparator 264. One of the two output terminals is connected to the subtraction device 269, and the other of the two output terminals is connected to the register 268.

When the AD conversion unit 266 outputs an AD-converted result indicating no-signal (no-signal in digital), the switch 267 provides this signal to the register 268, and has the signal latched (held) by the register 268. Therefore, the value of offset of the comparator 264 and the AD conversion unit 266 is held in the register 268 as the reset level. When the AD conversion unit 266 outputs the AD-converted result of actual accumulation signal (actual accumulation signal in digital), the switch 267 provides this signal to the subtraction device 269.

The register 268 is to hold the AD-converted result of no-signal including noise component. The register 268 provides the AD-converted result of no-signal held therein (no-signal in digital) to the subtraction device 269. It should be noted that the register 268 is an example of a noise component holding unit described in claims.

The subtraction device 269 is configured to subtract the value of no-signal in digital from the value of actual accumulation signal in digital. The subtraction device 269 provides the subtraction result (actual digital value) to the binary determination unit 270. It should be noted that the subtraction device 269 is an example of a noise component elimination unit described in claims.

The binary determination unit 270 is configured to perform binary determination (digital determination). This binary determination unit 270 compares the output of the subtraction device 269 (actual digital value) and the reference signal (REF) and makes binary determination of presence/absence of incidence of a photon onto the pixel 230, and outputs the determination result to the register 268. In FIG. 5, “BINOUT” indicates this determination result.

### “Example of Operation of Detection Circuit”

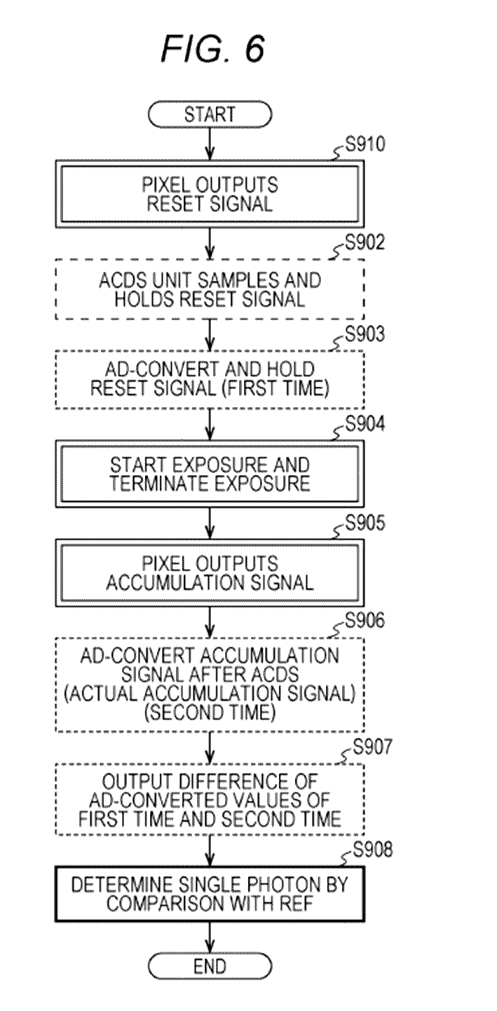

FIG. 6 is a flowchart illustrating an example of operation of the detection circuit 260 according to the first embodiment. A frame of each procedure in the flowchart shown in the drawing indicates a configuration for executing that procedure. More specifically, a procedure indicated by a double frame means a procedure for the pixel 230. A procedure indicated by a frame of a long broken line means a procedure of the analog CDS circuit 261. A procedure indicated by a frame of a short broken line means a procedure of the digital CDS circuit 265. A procedure indicated by a frame of a thick solid line means a procedure of the binary determination unit 270. For the sake of convenience of explanation, analog CDS processing by the analog CDS circuit 261 is not shown in the drawing. The analog CDS processing will be explained in the explanation about the procedure when the digital CDS circuit 265 executes the AD conversion.

First, a pixel 230 in the selected row reset the potential at the floating diffusion layer (node 235) in accordance with the control of the drive circuit 210, and outputs the reset signal to the vertical signal line 239 (step S901).

Subsequently, the reset signal which is output from the pixel 230 is held by the capacitor 263 of the analog CDS circuit 261 (step S902). Thereafter, the signal of the difference between the stored reset signal and the reset signal that is output from the pixel 230 (no-signal) is AD-converted by the AD conversion unit 266 of the digital CDS circuit 265 (step S903). It should be noted that the AD-converted no-signal includes noises generated by the comparator 264 and the AD conversion unit 266, and is made by digitally detecting the value for cancelling (offsetting) the noises. Then, the AD-converted result of the no-signal is held in the register 268 as the offset value. On the other hand, the pixel 230 starts the exposure, and terminates the exposure after the exposure time which has been set in advance has passed (step S904). In this case, the exposure time is set as a time shorter than the sampling period.

Subsequently, electrons accumulated by the photodiode 233 in the pixel 230 are transferred to the floating diffusion layer (node 235), the pixel 230 outputs the accumulation signal (step S905). Thereafter, the signal of the difference between the sampled and held reset signal and the accumulation signal that is output from the pixel 230 (actual accumulation signal) is AD-converted by the AD conversion unit 266 of the digital CDS circuit 265 (step S906). It should be noted that this AD-converted result includes noises generated by the comparator 264 and the AD conversion unit 266.

Then, the subtraction device 269 in the digital CDS circuit 265 outputs a value which is obtained by subtracting the value of the AD-converted result of the no-signal held in the register 268 (first time) from the value of the AD-converted result of the actual accumulation signal (second time) (step S907). Accordingly, noises caused by the comparator 264 and the AD conversion unit 266 (offset components) are cancelled, and the digital value of only the accumulation signal which is output by the pixel 230 (actual digital value) is output.

Thereafter, the actual digital value that is output from the subtraction device 269 and the reference signal (REF) are compared by the binary determination unit 270. The reference signal (REF) is set as a value close to an intermediate value (e.g. “50”) between the digital value of the signal that is output by the pixel 230 when there does not exist any photon incidence (e.g., “0”) and the digital value of the signal that is output by the pixel 230 when there exists photon incidence (e.g., “100”). After step S908, the detection circuit 260 finishes a set of operation.

In a case where the value of the digital value that is output by the subtraction device 269 (the digital value of only the accumulation signal that is output by the pixel 230) is more than the value of the reference signal (REF), the binary determination unit 270 outputs a signal of value “1” (BINOUT) indicating “presence of photon incidence”. On the other hand, in a case where the value of the digital value that is output by the subtraction device 269 is not more than the value of the reference signal (REF), the binary determination unit 270 outputs a signal of value “0” (BINOUT) indicating “absence of photon incidence”. More specifically, the image-capturing device 200 outputs the digital value (0 or 1) of the binary determination result indicating whether the photon incidence is present and absent (step S908). After step S908, the image-capturing device 200 finishes the output operation of the digital value in the selected section.

In the explanation with FIG. 5 and FIG. 6, two-value determination (binary determination) for determining “presence of photon incidence” and “absence of photon incidence” is considered to be made. Alternatively, determination of two or more values can be made by preparing multiple reference signals (REF). For example, two reference signals (REF) are prepared. One of the reference signal (REF) is configured to be an intermediate value between the digital value where the number of photons is “0” and the digital value where the number of photons is “1”. The other of the reference signal (REF) is configured to be an intermediate value between the digital value where the number of photons is “1” and the digital value where the number of photons is “2”. Accordingly, the number of photons can be determined to be three levels “0”, “1”, “2”, and this improves the dynamic range of image-capturing process. This kind of multi-value determination is greatly affected by variation of the conversion efficiency and the like of each pixel, and therefore, it is necessary to produce the two-value determination with a higher degree of accuracy. However, in terms of treating a signal generated by a pixel as a digital output, this is the same as the binary determination for determining only the presence/absence of photon incidence (whether 0 or 1) from a signal generated by a pixel. With the digital CDS, the noises in the transmission associated with analog output are completely eliminated.

In light detection under environment where luminance is relatively high, for example, several or more photons in average enter each pixel, the step of the binary determination in step S908 may be omitted, and the digital value of step S907 before step S908 may be adopted as received light quantity value of each pixel.

The digital CDS circuit 265 cancels not only offset at the detection device but also low frequency component of random noises of the pixel signal that appears in the vertical signal line 239, but in addition, the digital CDS circuit 265 can also cancel the high frequency component. For example, the high frequency component can be cut by connecting, for example, an appropriate band width cut capacitance to the vertical signal line 239. As described above, for the pixel 230, the random noises of the pixel signal can be narrowed down from both of the low frequency side and the high frequency side, and the detection can be made with a high degree of accuracy in the order one a single photon.

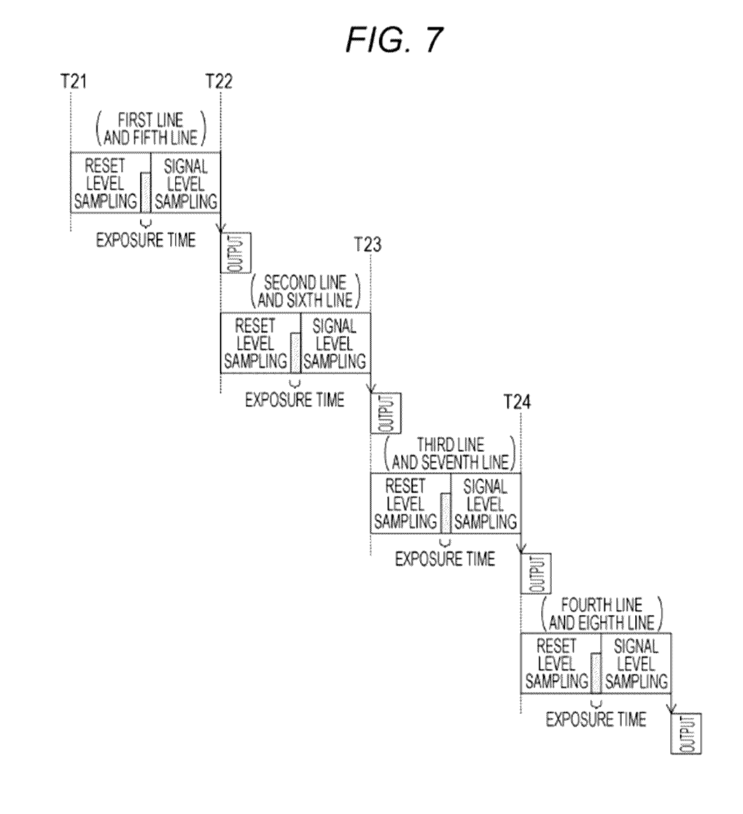

FIG. 7 is a figure illustrating an example of exposure control when a two-dimensional image is obtained according to the first embodiment. The drive circuit 210 performs exposure control by selecting the four sections one by one in order.

For example, first, the drive circuit 210 selects the section including the first row and the fifth row at a time T21, the drive circuit 210 turns off the FD reset transistor 236 to start sampling of the reset level. Then, the drive circuit 210 starts the exposure accumulation within the sampling period. When the sampling period elapses, the drive circuit starts sampling of the signal level.

In a strict sense, the sampling does not start as soon as the drive circuit 210 controls the FD reset transistor 236 into the OFF state at the time T21. Or rather, the sampling starts when a certain period of time passes from that point in time as described above. However, this period is extremely short, and therefore, for the sake of convenience of explanation, FIG. 7 indicates that the sampling starts at the time T21. This is also applicable to the second subsequent sections.

When the sampling of the first section is finished at a time T22, the detection circuit 260 outputs an accumulation signal obtained from the reset level and the signal level. The drive circuit 210 performs the same exposure control upon selecting the second section including the second row and the sixth row.

As described above, the series of exposure processing including the sampling of the reset signal, the exposure accumulation, and the sampling of the signal level, and the output is done in a circulating manner. The difference signal that is output as the result is once held in the register 286, and the transfer and the output of the difference signal in the chip are executed as a pipeline via the register 286.

When the sampling of the second section is finished in the time T23, the drive circuit 210 selects the third section and executes the same exposure control. When the sampling of the third section is finished in the time T24, the drive circuit 210 selects the final section and executes the same exposure control.

The control for exposure upon selecting multiple sections in order as described above will be referred to as a rolling shutter method. For example, the control as shown in FIG. 7, for example, is executed when a two-dimensional image is captured in an extremely bright location with the exposure time being an extremely short period of time.

On the other hand, when the image-capturing device 200 explained above is used as a single light detection device, and the light emission pulse and the like by the scintillation are detected, as much as only a single section is exposed in each pulse. Therefore, the drive circuit 210 may select only a single section of the four sections, and may repeatedly execute the exposure control in that section.

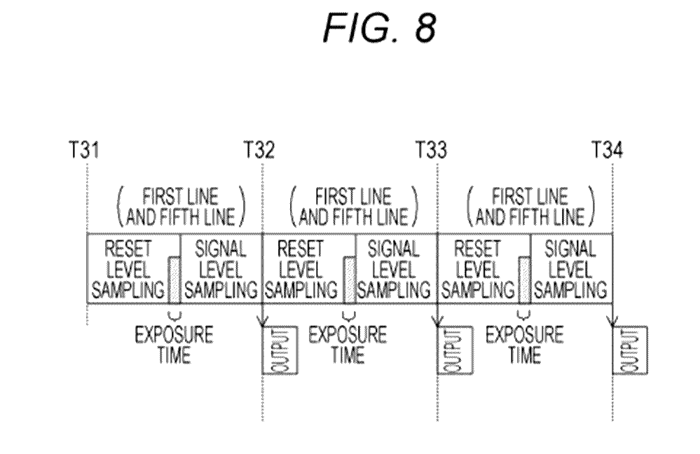

FIG. 8 is a figure illustrating an example of the exposure control when the light detection according to the first embodiment is performed. For example, the drive circuit 210 selects only the first section (the first row and the fifth row). Then, the drive circuit 210 repeatedly executes the series of exposure control including the sampling of the reset signal, the exposure accumulation, the sampling of the signal level, and the output with regard to that section in question. The difference signal that is output as the result is once held in the register 286, and the transfer and the output of the difference signal in the chip are executed as a pipeline via the register 286. The binary determination is executed as necessary outside of the chip or the output circuit 287.

In general, the control for causing all the pixels in the image-capturing device to operate at a time and causes them to be exposed at the same time is called a global shutter method. In FIG. 8, the same exposure control as that of the global shutter method is executed not in all the pixels of the image-capturing device but in only the single section. With this exposure control, only the light pulse that has entered the image-capturing device 200 within the exposure time is detected. It should be noted that the same driving is executed even in a case where the image-capturing device 200 is used for a line sensor detection device for scanner.

Even if it takes totally five microsecond (us) to access a single section, the exposure control as shown in FIG. 8 can reduce the exposure time to, for example, 50 nanosecond (ns). Therefore, in the repetition of the exposure of the single section in the cycle of five microsecond (us), the exposure time is 1/100 thereof, i.e., only 50 nanoseconds, and the light pulses emitted by radiation which have entered in the time other than the exposure time are not detected, and are disregarded. Therefore, the data processing unit 140 corrects the number of light pulses in accordance with the ratio between the measurement period from the start of the sampling of the reset level to the end of the sampling of the signal level and the exposure time. For example, when the exposure time is 1/100 of the measurement period, the data processing unit 140 multiplies the number of light pulses detected in the exposure time by about 100, thus estimating the number of radiations incident upon the scintillator. As described above, the radiation detection apparatus 100 can measure the number of highly frequent radiation incidence.

As described above, according to the first embodiment of the present technique, the image-capturing device 200 transfers the electrical charge from the photoelectric conversion device to the floating diffusion layer when the exposure time, which is shorter than the sampling period, has passed, and therefore, the exposure time can be shorter than the sampling period. Therefore, the accuracy of the photon counting can be improved.

For a generally-available CMOS imager, such extremely short period of time exposure is useful for image-capturing and the like in a high illumination environment, but as explained below, the temporal resolution of the radiation photon counting can be drastically improved.

Further, the image-capturing device 200 using the present technique can also be used as a low-cost simplified receiver for optical communication.

When this image-capturing device 200 is used for detection of scintillation light of radiation, the radiation detection apparatus 100 can drastically improve the dynamic range of detection in the radiation counting. Therefore, radiation counting (photon counting) can be introduced to not only the gamma camera but also the CT apparatus, mammography, and the like, and this allows for discrimination of scattered radiation based on energy and energy analysis of radiation.

When this radiation detection apparatus 100 used for a dosimeter, the energy detection of the radiation and the photon counting can be done at the same time, and therefore, for example, the counting rate according to the energy of the radiation can be measured. More specifically, the energy spectrum of the radiation can be measured. Therefore, for example, dose correction according to, for example, G function method and DBM (Discrimination Bias Modulation), described in JP 2004-108796 A can be appropriately carried out. In addition, the output of the radiation detection apparatus 100 has already made into digital, and therefore, it is not necessary to provide a multi-channel analyzer, and all the post-processing including the correction can be done using a low-cost single-chip microcomputer. Therefore, a light weight, highly accurate, and still low-cost dosimeter can be achieved.

### “First Modification”

In the first embodiment explained above, the image-capturing device 200 carries out exposure by configuring that the exposure time is less than the sampling period, but in such case, in the measurement period, there is a dead period which is not used for the light detection (this is a period of the measurement period other than the exposure time). However, for low frequency radiation incidence, this dead period preferably does not exist so as to allow for counting a small number of times of incidence without missing. Therefore, when the exposure time is configured to be closer to the measurement period according to the operation control based on an ordinary CMOS imager, the pulses of the scintillation light can be counted without missing. More specifically, the exposure period is preferably changed in accordance the frequency of the detection of the radiation. An image-capturing device 200 according to the first modification of the first embodiment is different from the first embodiment in that the exposure time is changed in accordance with the frequency of the detection of the radiation.

More specifically, a data processing unit 140 of the image-capturing device 200 according to the first modification measures the frequency of the detection of the radiation from the number of times radiation is detected within a certain period of time every time the certain period of time passes. Then, the data processing unit 140 provides the image-capturing device 200 with a control signal indicating whether the frequency of the detection is higher than a predetermined frequency or not.

The image-capturing device 200 according to the first modification can control the PD reset transistor 231 into the OFF state even before the point in time at which the FD reset transistor 236 is turned OFF. By controlling the PD reset transistor 231 into the OFF state before the point in time at which the FD reset transistor 236 is turned OFF, the image-capturing device 200 can set the exposure time to a time equal to or more than the sampling period.

When the frequency of the detection of the radiation is more than a predetermined frequency, the image-capturing device 200 sets the exposure time to a time less than the sampling period. If not the case, the image-capturing device 200 sets the exposure time to a time equal to or more than the sampling period.

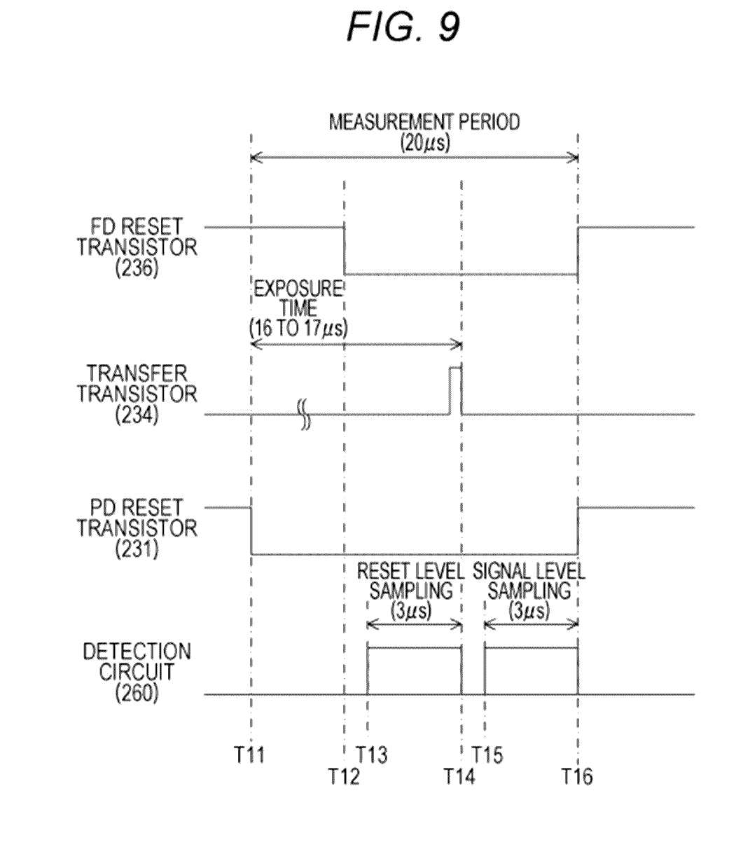

FIG. 9 is a timing chart illustrating an example of control of the pixel 230 according to the first modification of the first embodiment. For example, the drive circuit 210 carries out the sampling of the reset level and the signal level with predetermined timing and predetermined interval, and changes only the timing of the start of the exposure, thus changing the exposure time.

When the frequency of the detection of the radiation is equal to or less than the predetermined frequency, the drive circuit 210 turns off the PD reset transistor 231 to start the exposure at a time T11, and thereafter, turns OFF the FD reset transistor 236 at a time T12 after that. At a time T13 after that, the detection circuit 260 starts the sampling of the reset level. Then, at a time T14, the drive circuit 210 controls the transfer transistor 234 to terminate the exposure. At a time T14, the sampling of the reset level is finished. At a time T15 when the exposure is finished, the detection circuit 260 starts the sampling of the signal level, and finishes the sampling of the signal level at a time T16.

On the other hand, when the frequency of the detection of the radiation is more than the predetermined frequency, the drive circuit 210 executes the exposure by setting the exposure time to a time less than the sampling period as shown in FIG. 4, for example.

As shown in FIGS. 4 and 9, for example, the drive circuit 210 according to the first modification can change the point in time at which the PD reset transistor 231 is turned OFF in such a manner that the point in time at which the PD reset transistor 231 is turned OFF is before, on, or after the point in time at which the FD reset transistor 236 is turned OFF. When it takes three microseconds (us) to sample the signal level and when the measurement period is 20 microseconds (us), the exposure can be done for up to about 16 to 17 microseconds (us). On the other hand, in the shortest case, the exposure can be done in the order of several dozen nanoseconds (ns), which is, for example, 50 nanoseconds. Each of the exposure time in the case where the frequency of the detection of the radiation is more than the predetermined frequency and the exposure time in the case where the frequency of the detection of the radiation is not more than the predetermined frequency are set as any given value based on measurement condition within a range of 50 nanoseconds to 16 microseconds.

For example, a case where the radiation detection apparatus 100 receives light pulses about million times per second is considered. In this case, in average, the pulse incidence is once per microsecond (us). Under this condition, the radiation detection apparatus 100 determines that the frequency of the detection of the radiation is more than the predetermined frequency, and sets the exposure time to 0.1 microsecond (which is 100 nanoseconds). As a result, in average, pulses enter for 0.1 time within the exposure time. Therefore, the radiation detection apparatus 100 can substantially accurately discriminate multiple different pulses.

When the radiation detection apparatus 100 repeats the exposure with a cycle of 20 microseconds (us), data for fifty thousand times can be obtained per second, and therefore, about five thousand pulses can be counted. The radiation detection apparatus 100 multiplies this counted number by a ratio “200” between the measurement period (20 microseconds) and the exposure time (0.1 microsecond), then the number of incident pulses per unit time can be derived.

On the other hand, when only 100 pulses are received per second, the radiation detection apparatus 100 determines that the frequency of the detection is equal to or less than the predetermined frequency, the exposure time is set to 16 microseconds which is the maximum. As a result, about 80 pulses per second are detected, and therefore, the radiation detection apparatus 100 can derive the number of incident pulses by multiplying the number of pulses by the ratio between the cycle time and the exposure time (20/16=1.25).

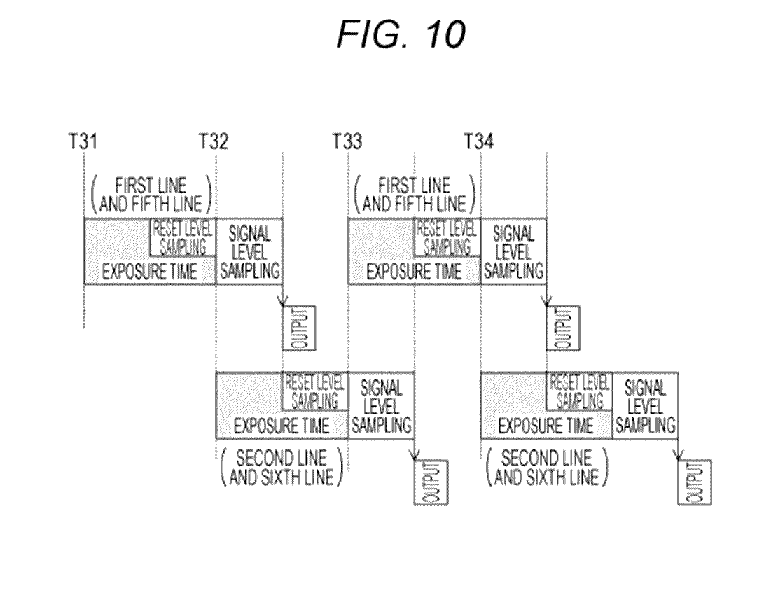

FIG. 10 is a figure illustrating an example of the exposure control when long exposure is performed according to the first modification of the first embodiment. In the drawing, the detection frequency of radiation is considered to be equal to or less than the predetermined frequency, and exposure is considered to be executed over a long period of time. In this case, for example, the drive circuit 210 alternately selects the first section (the first row and the fifth row) and the second section (the second row and the sixth row), and executes the exposure accumulation and the sampling in the selected section. When it takes about 5 microseconds (us) to sample the reset level and the signal level, these sections are selected with an interval of about 5 microseconds (us). It should be noted that the exposure period of each of them is also set to 5 microseconds. As described above, the exposure period is set, so that any of the sections is exposed at all times, and the dead period is eliminated in the entire image-capturing device 200. The temporal resolution of the light pulse detection is five microseconds (us).

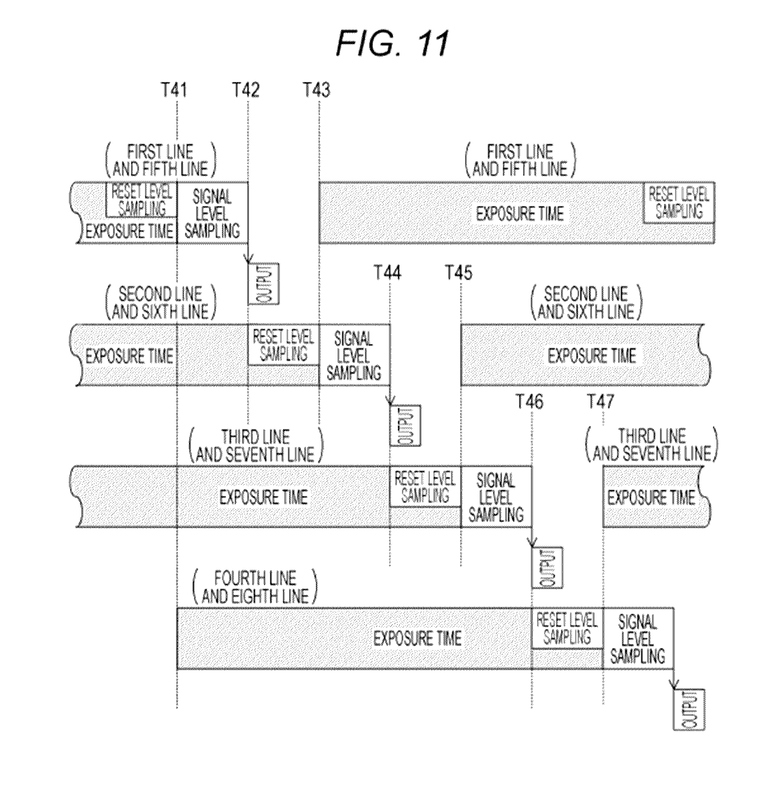

FIG. 11 is a figure illustrating an example of exposure control for selecting the sections in order according to the first modification of the first embodiment. In the drawing, the frequency of the detection of the radiation is considered to be equal to or less than the predetermined frequency.

The drive circuit 210 selects the four sections with an interval of about five microseconds (us) in order, and sets the exposure time to 15 microseconds (us). In this setting, three sections are exposed at all times. As compared with the control as shown in FIG. 10 for example, the temporal resolution decreases to 15 microseconds, but the number of pixels exposed is three times, and therefore, the detection sensitivity for the light pulse is improved. More specifically, in the exposure control as shown in FIG. 11 for example, the accuracy of measurement of the pulse strength is improved. Therefore, when the measurement accuracy of the pulse strength is given higher priority over the improvement of the temporal resolution, the exposure control for selecting all the sections in order is executed as shown in FIG. 11, for example.

As described above, according to the first modification, the exposure time is changed on the basis of the frequency of the detection of the radiation, and therefore, the exposure can be done with the appropriate exposure time.

### “Second Modification”

In the first modification of the first embodiment explained above, the single optical guide 130 and the single image-capturing device 200 are provided. However, multiple optical guides 130 and multiple image-capturing devices 200 may be provided. The radiation detection apparatus 100 according to the second modification of the first embodiment is different from the first modification in that the radiation detection apparatus 100 according to the second modification of the first embodiment is provided with multiple optical guides 130 and multiple image-capturing devices 200.

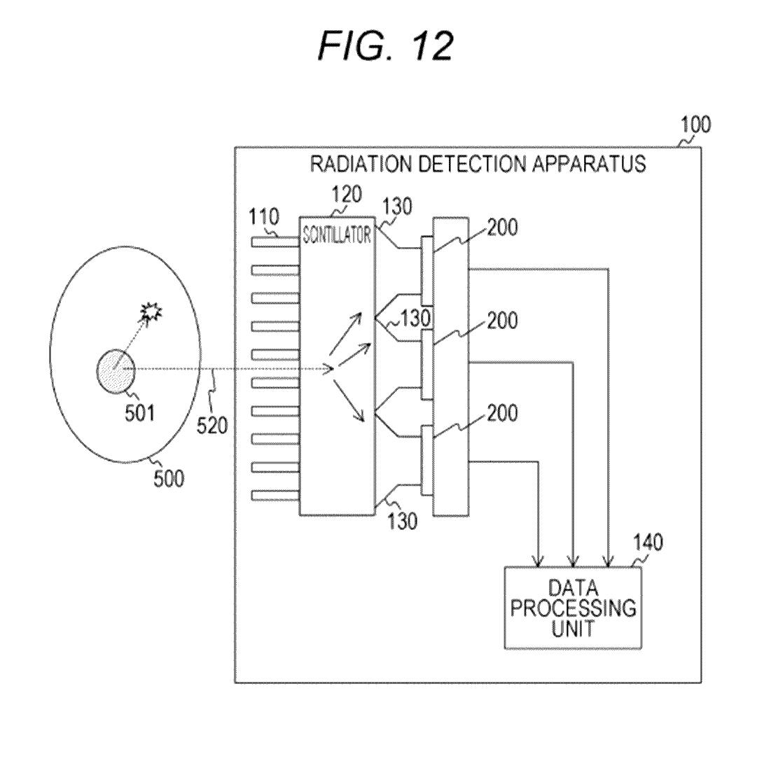

FIG. 12 is a block diagram illustrating an example of a configuration of the radiation detection apparatus 100 according to the second modification of the first embodiment. For example, the radiation detection apparatus 100 according to the second modification has three optical guides 130 for a single scintillator 120. For each optical guide 130, a single image-capturing device 200 is provided. More specifically, a single scintillator 120 is shared by three optical guides 130 and three image-capturing devices 200. The radiation detection apparatus 100 according to the second modification may be configured such that less than three or more than three image-capturing devices 200 may be provided for a single scintillator 120.

Like the first embodiment each image-capturing device 200 is divided into multiple sections, but, for example, one of these sections is detected for detection of radiation.

The data processing unit 140 receives output from each of the image-capturing devices 200, and discriminates the noises and determines the position with regard to each radiation (e.g., gamma ray). When the scintillator 120 is constituted by a single plate, the light emission thereof is detected by the multiple image-capturing device 200 at the same time. The data processing unit 140 derives the energy of the gamma ray from the summation of the outputs of the events that occurred at the same time, for example, and identifies the incident position of the gamma ray from the barycenter of the outputs. Thus, the number of events of the gamma ray that are determined to be primary (not noises) are counted, and the in-vivo distribution of the gamma-ray source is identified.

The data processing unit 140 for determining the energy of the radiation and the incident position from the outputs of the multiple image-capturing devices 200 may vary in various manners according to the digital processing of already-available gamma cameras. As compared with a photomultiplier tube, the image-capturing device 200 is small, light weight, and low-cost, and therefore, many image-capturing devices 200 can be implemented with a higher density, and therefore, the detection accuracy of the incident position of the radiation is improved accordingly. Alternatively, if the image-capturing devices 200 are implemented with a higher density even in a case where multiple gamma rays enter at different positions substantially at the same time, the incidence appears in the strength distribution of the outputs, and therefore, they can be detected by determining the incidence by using pattern matching and the like.

In the image-capturing using multiple image-capturing devices 200, the exposure control as shown in FIG. 7 for example is executed for each of the image-capturing devices, so that the best image can be obtained.

For each image-capturing device 200, the exposure time may be controlled in accordance with the frequency of the detection of the radiation. For example, the data processing unit 140 measures the frequency of the detection of the radiation for each image-capturing device 200, and decreases the exposure time for an image-capturing device 200 of which frequency of the detection of the radiation is higher than a predetermined frequency, and increases the exposure time for an image-capturing device 200 of which frequency of the detection of the radiation is equal to or less than the predetermined frequency.

As described above, according to the second modification, multiple image-capturing devices 200 detect light, and therefore, the accuracy of photon counting can be improved.

### 2. Second Embodiment

In the first embodiment explained above, the image-capturing device 200 exposes multiple sections one by one in order, and in that case, the number of pixels exposed at a time is 64 pixels in two rows, and the light incident upon the other pixels is not detected. Or when detection result of each of 64 pixels for a single exposure is binary-determined, 64 is 26, and therefore, only six-bit gradation level is obtained in the energy detection. More specifically, in the configuration for exposing each section in order, the dynamic range of the energy detection is poor, and the dynamic range is limited by the number of pixels exposed at a time.

Therefore, a mechanism for performing exposure in an extremely short period of time at a time in multiple sections is required. This corresponds to a so-called global shutter operation in a CMOS image sensor. By exposing multiple sections at a time, many pixels can be used for light detection without increasing the circuit scale of the image-capturing device 200, and the dynamic range of the energy detection can be improved. The image-capturing device 200 according to this second embodiment is different from the first embodiment in that multiple sections are exposed at a time.

The image-capturing device 200 according to the second embodiment further includes a selection transistor (not shown) for each pixel in the pixel array unit 220. Then, the drive circuit 210 according to the second embodiment controls a selection transistor to select each section in order, and provides the output signals of the pixels in the selected section to the detection circuit 260.

### “Example of Configuration of Detection Circuit”

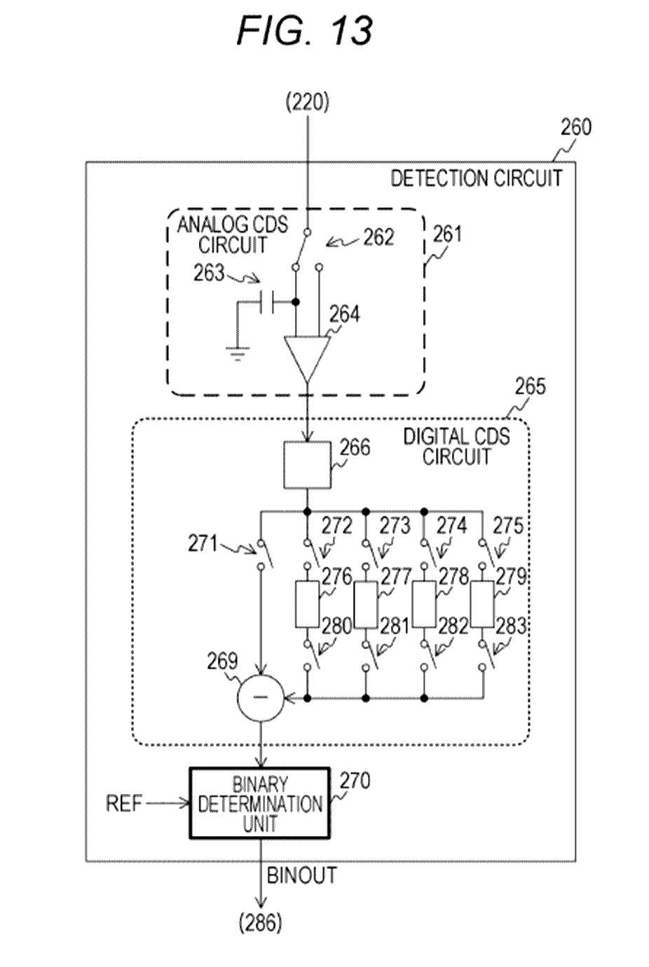

FIG. 13 is a figure illustrating an example of a configuration of the detection circuit 260 according to the second embodiment. The detection circuit 260 according to the second embodiment is such that the digital CDS circuit 265 is different from the first embodiment in that multiple switches and registers are provided.

The analog CDS circuit 261 according to the second embodiment is the same as the first embodiment. However, the analog CDS circuit 261 holds the signal of the reset level in the first row as the reference signal, and provides the reset signal in the first row to the digital CDS circuit 265. The analog CDS circuit 261 provides the difference between the reference signal and the output signal during resetting of the second and subsequent rows to the digital CDS circuit 265 as the reset signal of the second and subsequent rows.

The digital CDS circuit 265 includes as many registers as the number of rows connected to the digital CDS circuit 265. When four rows are connected, the digital CDS circuit 265 includes switches 271, 272, 273, 274, and 275, registers 276, 277, 278, and 279, and switches 280, 281, 282, and 283.

The switch 271 is configured to open/close the path between the AD conversion unit 266 and the subtraction device 269. One end of the switch 271 is connected to the AD conversion unit 266, and the other end thereof is connected to the subtraction device 269. The switch 271 is in the closed state in the sampling period of the signal level, and is in the open state in the other periods.

The switches 272 to 275 are configured to open/close the path between the AD conversion unit 266 and the corresponding registers. One end of the switch 272 is connected to the AD conversion unit 266, and the other end thereof is connected to the register 276. One end of the switch 273 is connected to the AD conversion unit 266, and the other end thereof is connected to the register 277. One end of the switch 274 is connected to the AD conversion unit 266, and the other end thereof is connected to the register 278. One end of the switch 275 is connected to the AD conversion unit 266, and the other end thereof is connected to the register 279.

These switches 272 to 275 are in the closed state in the sampling period of the reset level of the corresponding row, and are in the open state in the other periods. More specifically, the switch 272 is in the closed state in the sampling period of the reset level of the first row, and the switch 273 is in the closed state in the sampling period of the reset level of the second row. The switch 274 is in the closed state in the sampling period of the reset level of the third row, and the switch 275 is in the closed state in the sampling period of the reset level of the fourth row.

The registers 276 to 279 hold the reset levels of the corresponding rows. The register 276 holds the reset level of the first row. The register 277 holds the reset level of the second row. The register 278 holds the reset level of the third row. The register 279 holds the reset level of the fourth row.

The switches 280 to 283 are configured to open/close the path between the subtraction device 269 and the corresponding registers. One end of the switch 280 is connected to the register 276, and the other end thereof is connected to the subtraction device 269. One end of the switch 281 is connected to the register 277, and the other end thereof is connected to the subtraction device 269. One end of the switch 282 is connected to the register 278, and the other end thereof is connected to the subtraction device 269. One end of the switch 283 is connected to the register 279, and the other end thereof is connected to the subtraction device 269.

These switches 280 to 283 are in the closed state in the closed state in the sampling period of the signal level of the corresponding row, and are in the open state in the other periods. More specifically, the switch 280 is in the closed state in the sampling period of the signal level of the first row. The switch 281 is in the closed state in the sampling period of the signal level of the second row. The switch 282 is in the closed state in the sampling period of the signal level of the third row. The switch 283 is in the closed state in the sampling period of the signal level in the fourth row.

### “Example of Operation of Image-Capturing device”

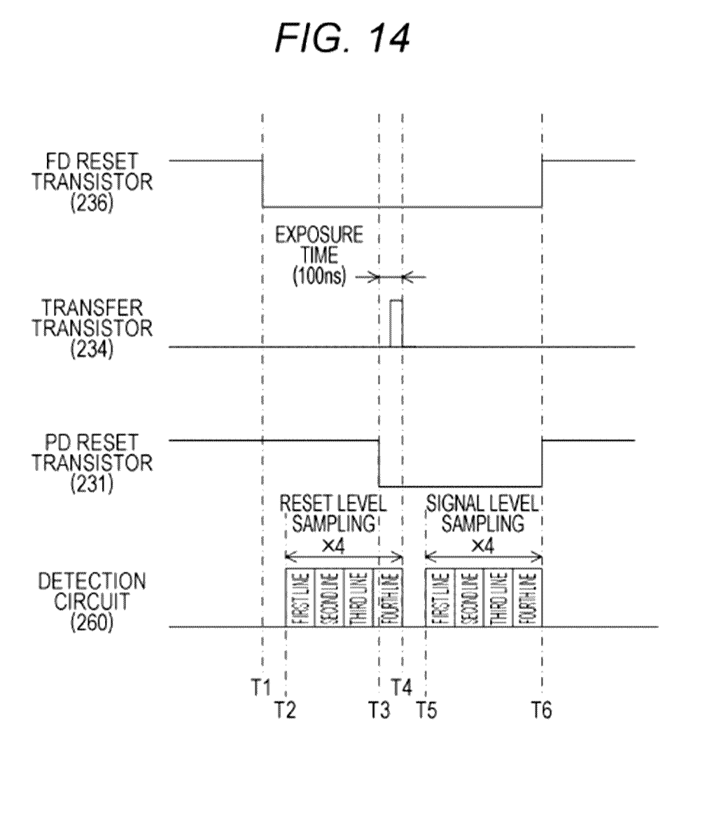

FIG. 14 is a timing chart illustrating an example of control of the pixel according to the second embodiment. In the initial state, suppose that the FD reset transistor 236 and the PD reset transistor 231 are in the ON state, and the transfer transistor 234 is in the OFF state.

The drive circuit 210 controls the FD reset transistors 236 of all the rows into the

OFF state at the time T1. Accordingly, the potential of the floating diffusion layer attains the floating state, and the potential reflecting the potential of the floating diffusion layer is output from the vertical signal line 239. The drive circuit 210 controls the selection transistors to provide the signals of the reset levels for the four rows to the detection circuit 260 in order.

Although the drive circuit 210 controls the FD reset transistors 236 for the four rows into the OFF state at the same time, the drive circuit 210 may also control the FD reset transistors 236 into the OFF state in order.

At a time T2 which is a certain period of time after the time T1, the detection circuit 260 starts sampling of the reset level of the first row and holds the reset level of the first row. Then, the detection circuit 260 samples and holds the reset levels of the second row to the fourth row in order.

Then, at a time T3 within the sampling period of the reset level, the drive circuit 210 controls the PD reset transistors 231 of all the rows into the OFF state. Accordingly, the photodiode 233 is reset, and the exposure accumulation of the signal electrical charge is started, which means that the exposure is started. In this case, the exposure time is considered to be set as the time shorter than the sampling period of the reset level of each row.

Immediately before a time T4 at which the exposure time, which has been set in advance, passes from the time T3, the drive circuit 210 controls the transfer transistors 234 of all the rows into the ON state, and transfers the signal electrical charge to the floating diffusion layer. Then, at a time T4 at which the exposure time has passed, the drive circuit 210 controls the transfer transistors 234 of all the rows into the OFF state. Thus, the exposure is completed. In addition, at this time T4, the sampling of the reset level of the fourth row is completed.

The drive circuit 210 controls the selection transistor to provide the accumulation signals for the four rows to the detection circuit 260 in order.

At a time T5 when a certain period of time has passed from the time T4, the detection circuit 260 samples the signal level of the first row. Subsequently, the detection circuit 260 samples the signal levels of the second row to the fourth row in order.

At a time T6 when the sampling of the signal level of the fourth row is finished, the drive circuit 210 the PD reset transistors 231 of all the rows into the ON state, thus discharging all the electrical charge of the photodiode 233.

In the control explained above, when the signal level of each row is sampled in order after the exposure is finished at T4, for example, the first row to the third row are sampled, the signal electrical charge of the fourth row is maintained in the floating diffusion layer. For example, when it takes two microseconds (us) to sample each row, the holding period during that time is about six microsecond (us). However, in the second embodiment in which the detection circuit 260 is shared by each row, the time for which the signal electrical charge is held at the floating diffusion layer of the final row increases in proportional to the increase of the number of pixels exposed at a time, and this may begin to cause the dark electric current of the floating diffusion layer. Therefore, the upper limit of the number of pixels exposed at a time is preferably equal to or less than 16.

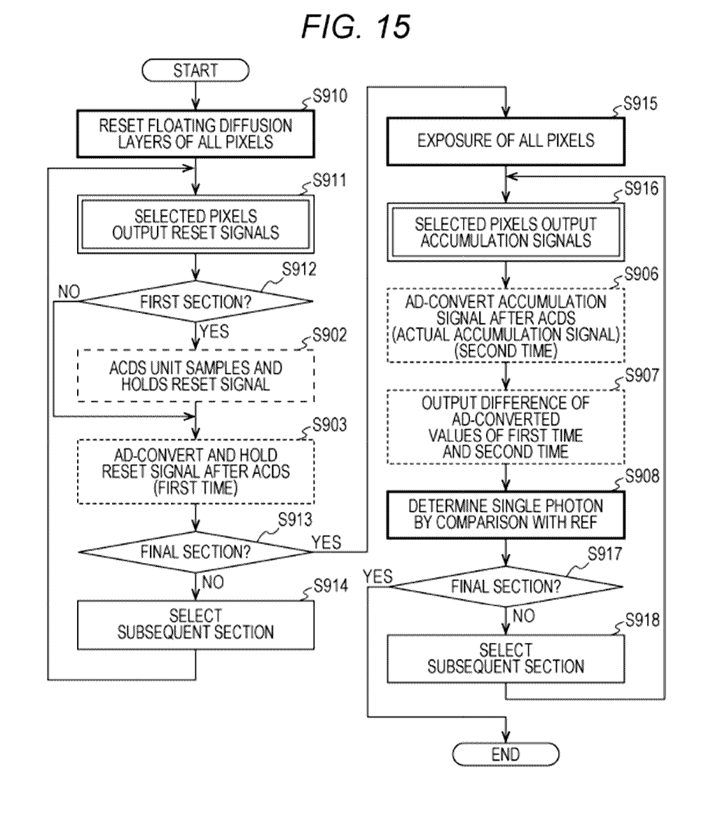

FIG. 15 is a flowchart illustrating an example of operation of the image-capturing device 200 according to the second embodiment.

First, all the pixels 230 reset the potentials of the floating diffusion layers (nodes 235) in accordance with the control of the drive circuit 210 (step S910). The drive circuit 210 selects any of the sections, and the pixels in the selected section output the reset signals (step S911).

The drive circuit 210 determines whether the selected section is the first section or not (step S912). When the rive circuit 210 determines that the selected section is the first section (step S912: Yes), the analog CDS circuit 261 (ACDS) detects the reset signal, and holds the reset signal as the reference signal (step S902). When the second or subsequent section is selected, the ACDS provides the difference between the reference signal and the output signal from the pixel 230 to the digital CDS circuit 265 (DCDS) as the reset signal.

In the case of the second or subsequent section (step S912: No), or after step S902, the DCDS converts the reset signal from the ACDS from analog into digital (step S903).

Then, the drive circuit 210 determines whether the selected section is the final section or not (step S913). When the drive circuit 210 determines the selected section is not the final section (step S913: No), the drive circuit 210 selects the subsequent section (step S914). After step S914, step S911 is executed again.

In the case of the final section (step S913: Yes), all the pixels 230 begin the exposure, and after the exposure time that has been set in advance elapses, the exposure is finished (step S915). In this case, the exposure time is set as a time shorter than the sampling period.

When the exposure is finished, the drive circuit 210 selects a section, and the pixel 230 in the selected section output the accumulation signal (step S916). Thereafter, the signal of the difference between the sampled and held reset signal and the accumulation signal which is output from the pixel 230 (actual accumulation signal) is converted from analog into digital by the DCDS (step S906).

Then, the DCDS outputs the value that is obtained by subtracting the value of the AD-converted result (first time) in the register 268 of the selected section from the AD-converted result (second time) of the actual accumulation signal (step S907).

Thereafter, the actual digital value which is output from the subtraction device 269 and the reference signal (REF) are compared by the binary determination unit 270, and the presence/absence of the photon incidence is output as the digital value of the binary determination result (step S908).

Then, the drive circuit 210 determines whether the selected section is the final section or not (step S917). When the drive circuit 210 determines that the selected section is not the final section (step S917: No), the drive circuit 210 selects a subsequent section (step S918). After step S918, step S916 is executed again. In the case of the final section (step S917: Yes), the image-capturing device 200 terminates the exposure control of all the sections.

As described above, according to the second embodiment, the pixels 230 of all the sections initialize the amounts of electrical charge accumulated in the photodiodes 233 (start the exposure), and the pixels 230 of all the sections transfer the electrical charge (terminate the exposure), and therefore, many pixels can be used for light detection. Therefore, the dynamic range of the detection of the energy of the radiation can be improved.

### “Modification”

In the second embodiment explained above, the image-capturing device 200 executes the exposure by setting the exposure time shorter than the sampling period, but the exposure period may be equal to or more than the sampling period based on the frequency of the detection of the radiation. The image-capturing device 200 according to the modification of the second embodiment is different from the second embodiment in that the exposure is executed upon switching the exposure time based on the frequency of the detection of the radiation.

More specifically, every time a certain period of time passes, a data processing unit 140 of an image-capturing device 200 according to a modification measures the frequency of the detection of the radiation from the number of times the radiation is detected within the certain period of time. Then, the data processing unit 140 provides the image-capturing device 200 with a control signal indicating whether the frequency of the detection is more than a predetermined frequency.

When the frequency of the detection of the radiation is more than the predetermined frequency, the image-capturing device 200 sets the exposure time to a time less than the sampling period. If not the case, the image-capturing device 200 sets the exposure time to a time equal to or more than the sampling period. Then, the exposure is performed.

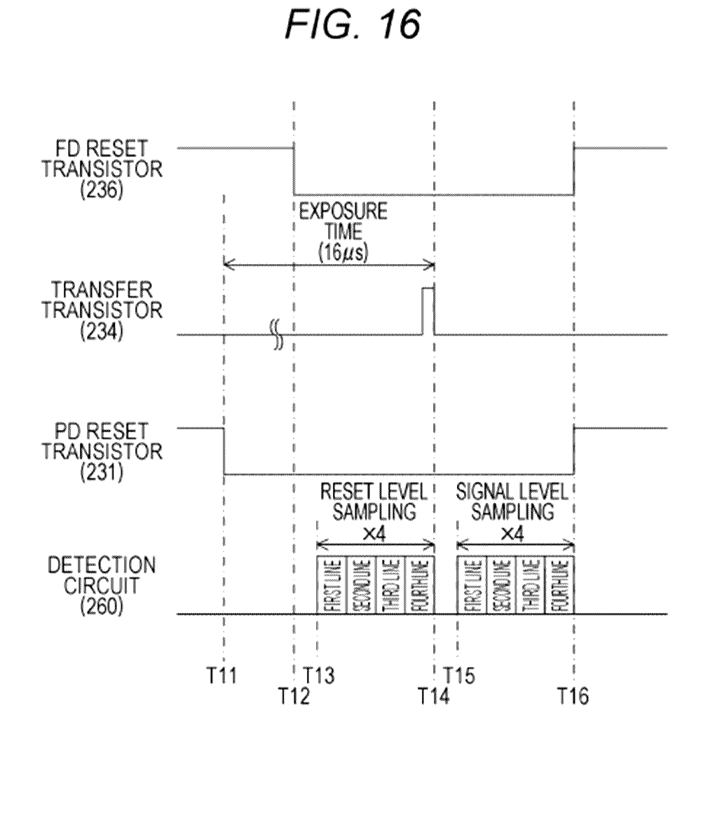

FIG. 16 is a timing chart illustrating an example of control of a pixel according to the modification of the second embodiment.

When the frequency of the detection of the radiation is equal to or less than the predetermined frequency, the drive circuit 210 turns OFF the PD reset transistor 231 and starts the exposure at a time T11, and thereafter turns OFF the FD reset transistor 236 at a time T12. At a time T13 after that, the detection circuit 260 starts sampling of the reset levels of all the rows. At a time T14, the drive circuit 210 controls the transfer transistor 234 to terminate the exposure. At a time T14, the sampling of the reset levels of all the rows are finished. The detection circuit 260 starts sampling of the signal levels of all the rows at a time T15, and then, at a time T16, the sampling of the signal levels of all the rows are finished.

As described above, according to the modification of the second embodiment, the exposure time is changed on the basis of the frequency of the detection of the radiation, and therefore, the exposure can be performed with an appropriate exposure time.

### 3. Third Embodiment

In the second embodiment explained above, the pixels 230 and the detection circuits 260 are provided on the same substrate. Alternatively, pixels may be provided on one of two substrates stacked by three dimensional silicon stacking technique, and detection circuits may be provided on the other of the two substrates. The radiation detection apparatus 100 according to the third embodiment is different from the first embodiment in that the pixels are provided on one of the two stacked substrates, and the detection circuits are provided on the other of the two substrates.

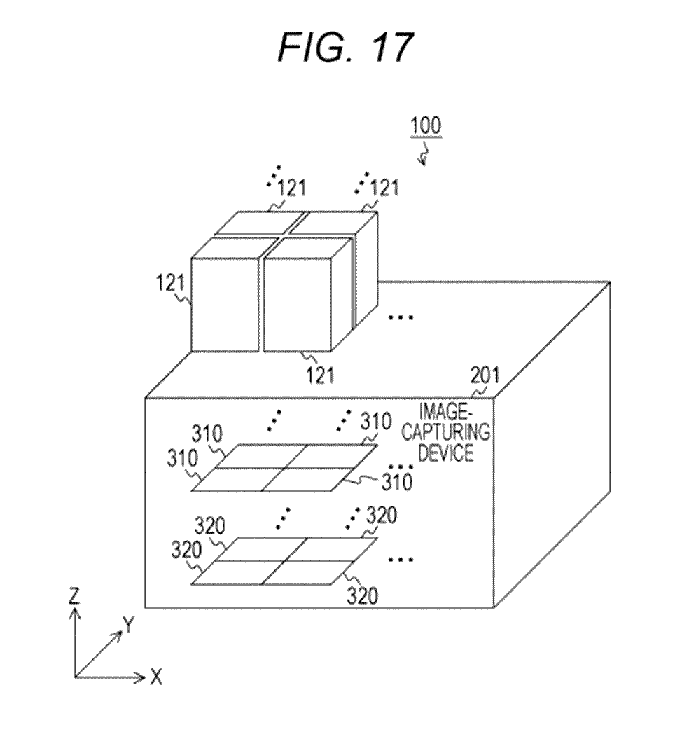

FIG. 17 is a perspective view illustrating an example of a configuration of a radiation detection apparatus 100 according to the third embodiment. The radiation detection apparatus 100 according to the third embodiment is different from the first embodiment in that multiple scintillator devices 121 and an image-capturing device 201 are provided instead of the scintillator 120, the optical guide 130, and the image-capturing device 200. In the drawing, a collimator 110 and a data processing unit 140 are not shown.

The image-capturing device 201 includes a drive circuit 210 (not shown) and two stacked substrates. The pixel blocks 310 are provide on one of the two substrates that is connected to the scintillator device 121, and the detection blocks 320 are provided on the other of the two substrates that is not connected to the scintillator device 121.

In each of the pixel blocks 310, four pixels are provided in 2 by 2 arrangement. A pixel arranged in the pixel block 310 is, for example, a back side illumination pixel in which light is emitted onto the back side where the photodiode is arranged.

The detection block 320 detects a voltage according to the amount of electrical charge accumulated in a pixel in the pixel block 310. The detection blocks 320 are arranged so as to be associated with the pixel blocks 310 so that the detection blocks 320 are associated with the pixel blocks 310 in one to one manner.

A pixel block 310 is pasted to a corresponding detection block 320 in wafer level, for example, so that a single detection unit is constituted by the pixel block 310 and the detection block 320. A certain number of detection units explained above are arranged in a two-dimensional lattice manner (e.g., 20 by 20) on a silicon chip of one square millimeter. It should be noted that the arrangement of the detection units may be flexibly configured in accordance with the usages, for example, transmission-type X-ray image-capturing, pulse counting in CT image-capturing, and the like.

As described above, the radiation detection apparatus 100 carries out the radiation detection with, for example, a cycle of 100 microseconds (us), and can execute an extremely short period of time exposure in less than 10 nanoseconds (ns). In this case, each unit can discriminate and detect radiation incident with an interval of 100 nanoseconds in average, and therefore, 1E7 radiations can be counted per second. In the radiation detection apparatus 100, totally 400 units can be operated in parallel, and each can independently detect the radiation. Therefore, the number of radiations that can be counted by modules (the image-capturing devices 200 and the scintillator devices 121) in one square millimeter per second is 4E9. More specifically, 4G/(s*mm̂2) radiations are measured.

The exposure period of each of the detection units can be independently controlled, and therefore, the optimum exposure setting can be made from preparative measurements for counting. A unit that has an extended exposure period having hardly any dead period can substantially accurately can make measurements even when several radiations enter per second.

In the CT image-capturing, for example, module in a square millimeter is adopted as a unit detection device, and the radiation counting is performed. The exposure control may be executed by a module unit at a time.

In the X-ray image-capturing, the modules are further laid, or modules having many detection units laid out are used to execute radiation counting. In this case, a single pixel is arranged in each detection unit of 50 square micrometers, and the exposure control is preferably carried out for each detection unit. The radiation detection apparatus that is achieved as described above can express even a very low radiation with a very clear contrast, and the radiation image-capturing can be executed with a high degree of sensitivity for low radiation.

The scintillator device 121 is a scintillator device formed in a pillar shape. Each scintillator device 121 is divided by a reflective material or a low-refraction material (not shown), the scintillation light is sealed inside of the pillar formed by the reflection material and the like. The scintillator device 121 is provided for each pixel block 310, for example.

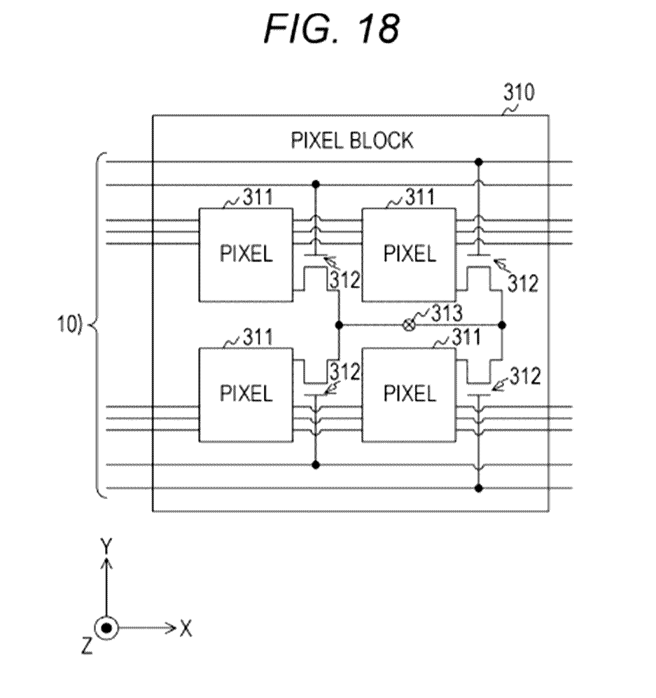

FIG. 18 is a figure illustrating an example of a configuration of a pixel block 310 according to the third embodiment. The pixel block 310 includes four pixels 311 arranged in two rows by two columns, four selection transistors 312, and an electrode pad 313. The selection transistor 312 may be, for example, a MOS transistor. The configuration of the pixel 311 is the same as the pixel 230 according to the first embodiment.

The selection transistor 312 is a transistor for selecting any of the pixels 230 and providing the detection block 320. The selection transistor 312 is provided for each pixel 311.

The gate of the selection transistor 312 is connected to the drive circuit 210, and the source of the selection transistor 312 is connected to the pixel 311, and the drain of the selection transistor 312 is connected via the electrode pad 313 to the detection block 320.

The drive circuit 210 controls the selection transistors 312 to provide the output signals of the four pixels 311 to the detection block 320 in order. The drive circuit 210 starts the exposure at a time and finishes the exposure at a time for the four pixels 311 in the pixel block 310. As described above, the drive circuit 210 can independently set the exposure time for each pixel block 310.

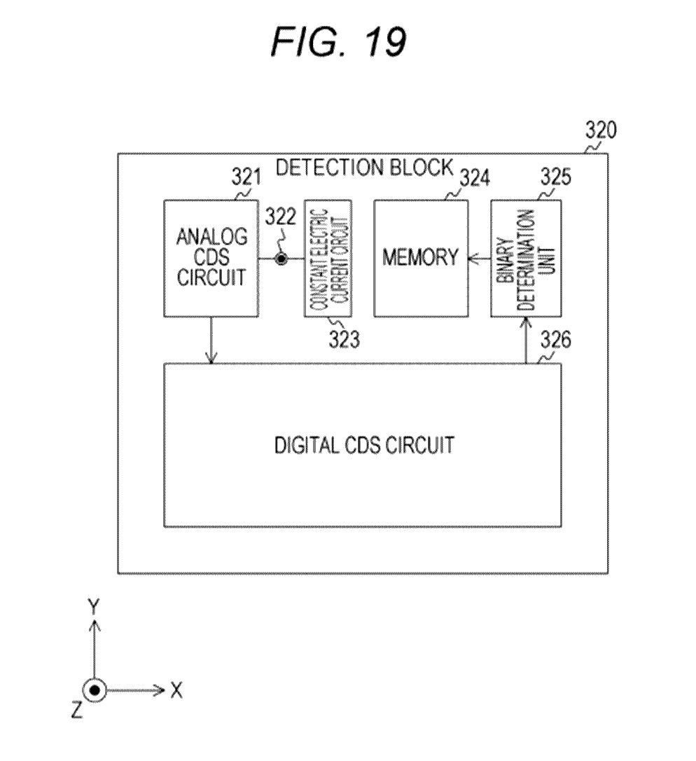

FIG. 19 is a block diagram illustrating an example of a configuration of a detection block 320 according to the third embodiment. This detection block 320 includes an analog CDS circuit 321, an electrode pad 322, a constant electric current circuit 323, a memory 324, a binary determination unit 325, and a digital CDS circuit 326.

The configurations of the analog CDS circuit 321, the digital CDS circuit 326, and the binary determination unit 325 are the same as the analog CDS circuit 261, the digital CDS circuit 265, and the binary determination unit 270 according to the second embodiment as shown in FIG. 14, for example.

The binary determination unit 325 causes the memory 324 to hold the generated digital value. This analog CDS circuit 321 receives the output signal via the electrode pad 322 from the pixel block 310. The digital value held in the memory 324 is read by the data processing unit 140 with appropriate timing.

The constant electric current circuit 323 is configured to provide a constant electric current. A source follower circuit is constituted by this constant electric current circuit 323 and the amplifier transistor in the pixel 311.

As described above, according to the third embodiment, pixels provided on one of the two stacked substrates, and the detection circuits are provided on the other of the two stacked substrates, and therefore, as compared with the configuration for arranging the detection circuits on the same substrate, the size of area of the light reception can be increased.

It should be noted that the embodiments explained above show examples for embodying the present technique, and the matters in the embodiments are related to the subject matters in claims. Likewise, the subject matters in claims are related to the matters in the embodiments of the present technique denoted with the same names as the subject matters in claims. However, the present technique is not limited to the embodiments, and can be embodied by applying various kinds of modifications to the embodiments without deviating from the gist of the present technique.

The processing procedure explained in the embodiments explained above may be understood as a method having the series of procedures, or may be understood as a program for causing a computer to execute the series of procedures and a recording medium for storing the program. Examples of recording media include a CD (Compact Disc), MD (Mini Disc), a DVD (Digital Versatile Disc), a memory card, Blu-ray disc (Blu-ray (registered trademark) Disc), and the like.

The effects described here are not particularly limited, and may be any of the effects described in this disclosure.

It should be understood by those skilled in the art that various modifications, combinations, sub-combinations and alterations may occur depending on design requirements and other factors insofar as they are within the scope of the appended claims or the equivalents thereof.

It should be noted that the present technique may also be configured as follows.
(1) An image-capturing device including:
a photoelectric conversion element configured to convert light into electrical charge and accumulate the electrical charge;
a floating diffusion region configured to generate a voltage according to an amount of electrical charge transferred from the photoelectric conversion element;
a floating diffusion region reset transistor configured to initialize the generated voltage;
a conversion unit configured to perform conversion processing for converting the voltage into a digital signal;
a photoelectric conversion element reset transistor configured to initialize the amount of electrical charge accumulated in the photoelectric conversion element at a predetermined point in time after the voltage is initialized; and
a transfer transistor configured to perform the transfer from the photoelectric conversion element to the floating diffusion region when an exposure time, which is shorter than the time required for the conversion processing, has elapsed from the predetermined point in time.
(2) The image-capturing device according to (1) above including a pixel array unit including a plurality of pixels each having the photoelectric conversion element, the floating diffusion region, the floating diffusion region reset transistor, the photoelectric conversion element transistor, and the transfer transistor,
wherein the pixel array unit is divided into a plurality of areas, and the conversion unit is configured to output the converted digital signal for each of the areas.
(3) The image-capturing device according to (2) above further including:
a holding unit configured to provide a noise component holding unit, for each of the areas, configured to hold a digital signal converted from the initialized voltage as a noise component; and
a noise elimination unit configured to perform noise elimination processing for eliminating the held noise component from the digital signal converted from the voltage when the transfer is performed,
wherein the photoelectric conversion element reset transistor initializes the amounts of electrical charge in all of the areas at the predetermined point in time,
the transfer transistor performs the transfer in all of the areas when the exposure time has passed from the predetermined point in time, and
the conversion unit performs the conversion processing on each of the initialized voltage and the voltage when the transfer is performed, thus converting, into the digital signal, each of the initialized voltage and the voltage when the transfer is performed.
(4) The image-capturing device according to (2) or (3) above, further including:
a noise component holding unit configured to hold a digital signal converted from the initialized voltage as a noise component of any of the areas; and
a noise elimination unit configured to perform noise elimination processing for eliminating the held noise component from the digital signal converted from the voltage when the transfer is performed,
wherein the photoelectric conversion element reset transistor initializes the amount of electrical charge in any of the areas, and
the transfer transistor performs the transfer in any of the areas.
(5) The image-capturing device according to (1) above including:
a conversion unit arrangement substrate having the conversion unit arranged thereon; and
a pixel arrangement substrate having the photoelectric conversion element, the floating diffusion region reset transistor, the photoelectric conversion element transistor, and the transfer transistor which are arranged thereon, wherein the pixel arrangement substrate is stacked on the conversion unit arrangement substrate.
(6) A radiation detection apparatus including:
a scintillator configured to generate light when radiation has entered;
a photoelectric conversion element configured to convert light into electrical charge and accumulate the electrical charge;
a floating diffusion region configured to generate a voltage according to the amount of electrical charge transferred from the photoelectric conversion element;
a floating diffusion region reset transistor configured to initialize the generated voltage;
a conversion unit configured to perform conversion processing for converting the voltage into a digital signal;
a photoelectric conversion element reset transistor configured to initialize the amount of electrical charge accumulated in the photoelectric conversion element at a predetermined point in time after the voltage is initialized;
a transfer transistor configured to perform the transfer from the photoelectric conversion element to the floating diffusion region when an exposure time, which is shorter than the time required for the conversion processing, has elapsed from the predetermined point in time; and
a radiation detection unit configured to detect whether radiation has entered within an exposure time based on a digital signal from which the noise is eliminated.
(7) The radiation detection apparatus according to (6) including a plurality of image-capturing devices arranged with a plurality of pixels each having the photoelectric conversion element, the floating diffusion region, the floating diffusion region reset transistor, the conversion unit, the photoelectric conversion element transistor, and the transfer transistor, and
the detection unit is configured to detect whether the radiation has entered for each of the image-capturing devices.
(8) The radiation detection apparatus according to (6) or (7) above, wherein the radiation detection unit derives a frequency of detection of radiation from a number of detections of radiation within a certain period of time, and
when the frequency of the detection of the radiation is more than a predetermined frequency, the photoelectric conversion element transistor initializes the amount of electrical charge at the predetermined point in time after the voltage is initialized, and when the predetermined frequency is more than the frequency of the detection, the photoelectric conversion element transistor initializes the amount of electrical charge before the voltage is initialized.
(9) The radiation detection apparatus according to (8) above, wherein when the frequency of the detection of the radiation is more than the predetermined frequency, the transfer transistor performs the transfer when an exposure time, which is shorter than the time required for the conversion processing, has elapsed from the predetermined point in time, and
when the predetermined frequency is more than the frequency of the detection, the transfer transistor performs the transfer when the time required for the conversion processing has at least elapsed from the predetermined point in time.
(10) A control method for an image-capturing device, including:
a floating diffusion region reset procedure for causing a floating diffusion region reset transistor to initialize a voltage generated by a floating diffusion region configured to generate the voltage according to an amount of electrical charge transferred from a photoelectric conversion element configured to convert light into the electrical charge and accumulate the electrical charge;
a conversion procedure for causing a conversion unit to perform conversion processing for converting the voltage into a digital signal;
a photoelectric conversion element reset procedure for causing the photoelectric conversion element reset transistor to initialize the amount of electrical charge accumulated in the photoelectric conversion element at a predetermined point in time after the voltage is initialized; and
a transfer transistor configured to perform the transfer from the photoelectric conversion element to the floating diffusion region when an exposure time, which is shorter than the time required for the conversion processing, has elapsed from the predetermined point in time.
(11) An image-capturing device comprising: a photoelectric conversion element configured to convert light into electrical charge and accumulate the electrical charge; a floating diffusion region configured to generate a voltage according to an amount of electrical charge transferred from the photoelectric conversion element; a photoelectric conversion element reset transistor configured to initialize an amount of electrical charge accumulated in the photoelectric conversion element; and a transfer transistor configured to transfer the accumulated electric charge from the photoelectric conversion element to the floating diffusion region during an exposure time, wherein a start of the exposure time corresponds to a transition of the photoelectric conversion element reset transistor from a first state to a second state.
(12) The image-capturing device according to (11) above, further comprising: a pixel array unit including a plurality of pixels, each pixel of the plurality of pixels including the photoelectric conversion element, the floating diffusion region, a floating diffusion region reset transistor, the photoelectric conversion element reset transistor, a conversion unit, and the transfer transistor, wherein, the pixel array unit is divided into a plurality of areas, the floating diffusion region reset transistor is configured to initialize the generated voltage, and the conversion unit is configured to convert the generated voltage into a digital signal and output the converted digital signal for each area of the plurality of the areas.
(13) The image-capturing device according to (12) above, further comprising: a holding unit configured to provide a noise component holding unit for each area of the plurality of areas, wherein the noise component holding unit is configured to hold, as a held noise component, a digital signal converted from the initialized voltage; and a noise elimination unit configured to perform noise elimination processing to eliminate the held noise component from the digital signal converted from the generated voltage, wherein the photoelectric conversion element reset transistor initializes the amount of electrical charge in at least one area of the plurality of areas, the transfer transistor transfers the accumulated electric charge from the photoelectric conversion element to the floating diffusion for at least one area of the plurality of areas, and the conversion unit converts each of the initialized voltage and the generated voltage when the transfer of the accumulated electric charge from the photoelectric conversion element to the floating diffusion is performed.
(14) The image-capturing device according to (12) or (13) above, further comprising: a noise component holding unit configured to hold a digital signal converted from the initialized voltage as a held noise component for one or more of the areas; and a noise elimination unit configured to eliminate the held noise component from the digital signal converted from the generated voltage when the transfer of the accumulated electric charge from the photoelectric conversion element to the floating diffusion is performed, wherein the photoelectric conversion element reset transistor initializes the amount of electrical charge for one or more of the areas, and the transfer transistor performs the transfer of the accumulated electric charge from the photoelectric conversion element to the floating diffusion for one or more of the areas.
(15) The image-capturing device according to (11), further comprising: a conversion unit arrangement substrate including the conversion unit arranged thereon; and a pixel arrangement substrate including the photoelectric conversion element, the floating diffusion region reset transistor, the photoelectric conversion element reset transistor, and the transfer transistor are arranged thereon, wherein the pixel arrangement substrate is stacked on the conversion unit arrangement substrate.
(16) A radiation detection apparatus comprising: a scintillator configured to generate light when radiation enters the scintillator; a photoelectric conversion element configured to convert light into electrical charge and accumulate the electrical charge; a floating diffusion region configured to generate a voltage according to the amount of electrical charge transferred from the photoelectric conversion element; a photoelectric conversion element reset transistor configured to initialize an amount of electrical charge accumulated in the photoelectric conversion element; a transfer transistor configured to transfer the accumulated electric charge from the photoelectric conversion element to the floating diffusion region during an exposure time, wherein a start of the exposure time corresponds to a transition of the photoelectric conversion element reset transistor from a first state to a second state; and a radiation detection unit configured to detect whether radiation has entered within an exposure time based on a digital signal from which noise has been eliminated.
(17) The radiation detection apparatus according to (17) above, further comprising a plurality of image-capturing devices including a plurality of pixels, each pixel of the plurality of pixels including the photoelectric conversion element, the floating diffusion region, a floating diffusion region reset transistor, a conversion unit, the photoelectric conversion element reset transistor, and the transfer transistor, wherein, the pixel array unit is divided into a plurality of areas, the floating diffusion region reset transistor is configured to initialize the generated voltage, and the conversion unit is configured to convert the generated voltage into a digital signal and output the converted digital signal for each area of the plurality of the areas, and the radiation detection unit is configured to detect whether the radiation has entered the scintillator for each of the image-capturing devices.
(18) The radiation detection apparatus according to (16) or (17) above, wherein the radiation detection unit derives a frequency of the detected radiation based on a number of detections of radiation within a certain period of time, and when the frequency of the detected radiation is more than a predetermined frequency, the photoelectric conversion element reset transistor initializes the amount of electrical charge after the generated voltage is initialized, and when the predetermined frequency is more than the frequency of the detected radiation, the photoelectric conversion element reset transistor initializes the amount of electrical charge before the generated voltage is initialized.
(19) The radiation detection apparatus according to (18) above, wherein when the frequency of the detected radiation is more than the predetermined frequency, the transfer transistor transfers the accumulated electric charge from the photoelectric conversion element to the floating diffusion region during an exposure time, wherein the exposure time is shorter than a time required to convert the voltage into a digital signal, and when the predetermined frequency is more than the frequency of the detected radiation, the transfer transistor transfers the accumulated electric charge from the photoelectric conversion element to the floating diffusion region during an exposure time, wherein the exposure time is longer than a time required to convert the voltage into a digital signal.
(20) A control method for an image-capturing device, comprising: initializing a voltage generated by a floating diffusion region, wherein the floating diffusion region is configured to generate the voltage according to an amount of electrical charge transferred from a photoelectric conversion element configured to convert light into the electrical charge and accumulate the electrical charge; converting the voltage into a digital signal; causing a photoelectric conversion element reset transistor to initialize the amount of electrical charge accumulated in the photoelectric conversion element; and transferring the accumulated electric charge from the photoelectric conversion element to the floating diffusion region during an exposure time, wherein a start of the exposure time corresponds to a transition of the photoelectric conversion element reset transistor from a first state to a second state.
(21) The control method according to (20) above, further including a pixel array unit including a plurality of pixels divided into a plurality of areas, the method further comprising: initializing the generated voltage,
converting the generated voltage into a digital signal, and outputting the converted digital signal for each area of the plurality of the areas.
(22) The control method according to (21) above, further comprising: holding, as a held noise component, a digital signal converted from the initialized voltage; eliminating the held noise component from the digital signal converted from the generated voltage; initializing the amount of electrical charge in at least one area of the plurality of areas; transferring the initialized amount of electrical charge in at least one area of the plurality of areas; and converting each of the initialized voltage and the generated voltage when the transfer of the accumulated electric charge from the photoelectric conversion element to the floating diffusion is performed.
(23) The control method according to (21) or (22), further comprising: holding a digital signal converted from the initialized voltage as a held noise component for one or more of the areas; and eliminating the held noise component from the digital signal converted from the generated voltage when the transfer of the accumulated electric charge from the photoelectric conversion element to the floating diffusion is performed,
wherein the photoelectric conversion element reset transistor initializes the amount of electrical charge for one or more of the areas, and the transfer transistor performs the transfer of the accumulated electric charge from the photoelectric conversion element to the floating diffusion for one or more of the areas.
(24) The control method according to (20) above, further comprising: stacking a pixel arrangement substrate on a conversion unit arrangement substrate, wherein the pixel arrangement substrate includes the photoelectric conversion element, the floating diffusion region reset transistor, the photoelectric conversion element reset transistor, and the transfer transistor, and the conversion unit arrangement substrate includes the conversion unit.
(25) A control method for a radiation detection apparatus, comprising: initializing a voltage generated by a floating diffusion region, wherein the floating diffusion region is configured to generate a voltage according to an amount of electrical charge transferred from a photoelectric conversion element configured to convert light into the electrical charge and accumulate the electrical charge; converting the voltage into a digital signal; causing a photoelectric conversion element reset transistor to initialize the amount of electrical charge accumulated in the photoelectric conversion element; transferring the accumulated electric charge from the photoelectric conversion element to the floating diffusion region during an exposure time, wherein a start of the exposure time corresponds to a transition of the photoelectric conversion element reset transistor from a first state to a second state; and detecting whether radiation has entered within the exposure time based on a digital signal from which noise has been eliminated.
(26) The control method according to (25) above, further including a pixel array unit including a plurality of pixels divided into a plurality of areas, the method further comprising: initializing the generated voltage; converting the generated voltage into a digital signal; and outputting the converted digital signal for each area of the plurality of the areas.
(27)The control method according to (25) or (26) above, further comprising: deriving a frequency of the detected radiation based on a number of detections of radiation within a certain period of time, and when the frequency of the detected radiation is more than a predetermined frequency, initializing the amount of electrical charge after the generated voltage is initialized, and when the predetermined frequency is more than the frequency of the detected radiation, initializing the amount of electrical charge before the generated voltage is initialized.
(28) The control method according to (27) above, further comprising: transferring the accumulated electric charge from the photoelectric conversion element to the floating diffusion region during an exposure time when the frequency of the detected radiation is more than the predetermined frequency, wherein the exposure time is shorter than a time required to convert the voltage into a digital signal, and transferring the accumulated electric charge from the photoelectric conversion element to the floating diffusion region during an exposure time when the predetermined frequency is more than the frequency of the detected radiation, wherein the exposure time is longer than a time required to convert the voltage into a digital signal.

### REFERENCE SIGNS LIST

100 Radiation detection apparatus
110 Collimator
120 Scintillator
121 Scintillator device
130 Optical guide
140 Data processing unit
200, 201 Image-capturing device
210 Drive circuit
220 Pixel array unit
230 Pixel
231 PD reset transistor
232, 235, 313, 322 Node
233 Photodiode
234 Transfer transistor
236 FD reset transistor
237 Amplifier transistor
240, 260 Detection circuit
261, 321 Analog CDS circuit
262, 267, 271, 272, 273, 274, 275, 280, 281, 282, 283 switches
263 Capacitor
264 Comparator
265, 326 Digital CDS circuit
266 AD conversion unit
268, 276, 277, 278, 279, 285, 286 Register
269 Subtraction device
270, 325 Binary determination unit
287 Output circuit
310 Pixel block
311 Pixel
312 Selection transistor
320 Detection block
323 Constant electric current circuit
324 Memory

What is claimed is:

1. An image-capturing device comprising:
a photoelectric conversion element configured to convert light into electrical charge and accumulate the electrical charge;
a floating diffusion region configured to generate a voltage according to an amount of electrical charge transferred from the photoelectric conversion element;
a photoelectric conversion element reset transistor configured to initialize an amount of electrical charge accumulated in the photoelectric conversion element; and
a transfer transistor configured to transfer the accumulated electric charge from the photoelectric conversion element to the floating diffusion region during an exposure time, wherein a start of the exposure time corresponds to a transition of the photoelectric conversion element reset transistor from a first state to a second state.

2. The image-capturing device according to claim 1, further comprising:
a pixel array unit including a plurality of pixels, each pixel of the plurality of pixels including the photoelectric conversion element, the floating diffusion region, a floating diffusion region reset transistor, the photoelectric conversion element reset transistor, a conversion unit, and the transfer transistor, wherein,
the pixel array unit is divided into a plurality of areas,
the floating diffusion region reset transistor is configured to initialize the generated voltage, and
the conversion unit is configured to convert the generated voltage into a digital signal and output the converted digital signal for each area of the plurality of the areas.

2. The image-capturing device according to claim 2, further comprising:
a holding unit configured to provide a noise component holding unit for each area of the plurality of areas, wherein the noise component holding unit is configured to hold, as a held noise component, a digital signal converted from the initialized voltage; and
a noise elimination unit configured to perform noise elimination processing to eliminate the held noise component from the digital signal converted from the generated voltage, wherein the photoelectric conversion element reset transistor initializes the amount of electrical charge in at least one area of the plurality of areas,
the transfer transistor transfers the accumulated electric charge from the photoelectric conversion element to the floating diffusion for at least one area of the plurality of areas, and
the conversion unit converts each of the initialized voltage and the generated voltage when the transfer of the accumulated electric charge from the photoelectric conversion element to the floating diffusion is performed.

4. The image-capturing device according to claim 2, further comprising:
a noise component holding unit configured to hold a digital signal converted from the initialized voltage as a held noise component for one or more of the areas; and
a noise elimination unit configured to eliminate the held noise component from the digital signal converted from the generated voltage when the transfer of the accumulated electric charge from the photoelectric conversion element to the floating diffusion is performed,
wherein the photoelectric conversion element reset transistor initializes the amount of electrical charge for one or more of the areas, and
the transfer transistor performs the transfer of the accumulated electric charge from the photoelectric conversion element to the floating diffusion for one or more of the areas.

5. The image-capturing device according to claim 1, further comprising:
a conversion unit arrangement substrate including the conversion unit arranged thereon; and
a pixel arrangement substrate including the photoelectric conversion element, the floating diffusion region reset transistor, the photoelectric conversion element reset transistor, and the transfer transistor are arranged thereon, wherein the pixel arrangement substrate is stacked on the conversion unit arrangement substrate.

6. A radiation detection apparatus comprising:
a scintillator configured to generate light when radiation enters the scintillator;
a photoelectric conversion element configured to convert light into electrical charge and accumulate the electrical charge;
a floating diffusion region configured to generate a voltage according to the amount of electrical charge transferred from the photoelectric conversion element;
a photoelectric conversion element reset transistor configured to initialize an amount of electrical charge accumulated in the photoelectric conversion element;
a transfer transistor configured to transfer the accumulated electric charge from the photoelectric conversion element to the floating diffusion region during an exposure time, wherein a start of the exposure time corresponds to a transition of the photoelectric conversion element reset transistor from a first state to a second state; and
a radiation detection unit configured to detect whether radiation has entered within an exposure time based on a digital signal from which noise has been eliminated.

7. The radiation detection apparatus according to claim 6, further comprising a plurality of image-capturing devices including a plurality of pixels, each pixel of the plurality of pixels including the photoelectric conversion element, the floating diffusion region, a floating diffusion region reset transistor, a conversion unit, the photoelectric conversion element reset transistor, and the transfer transistor, wherein,
the pixel array unit is divided into a plurality of areas,
the floating diffusion region reset transistor is configured to initialize the generated voltage, and
the conversion unit is configured to convert the generated voltage into a digital signal and output the converted digital signal for each area of the plurality of the areas, and
the radiation detection unit is configured to detect whether the radiation has entered the scintillator for each of the image-capturing devices.

8. The radiation detection apparatus according to claim 6, wherein the radiation detection unit derives a frequency of the detected radiation based on a number of detections of radiation within a certain period of time, and
when the frequency of the detected radiation is more than a predetermined frequency, the photoelectric conversion element reset transistor initializes the amount of electrical charge after the generated voltage is initialized, and
when the predetermined frequency is more than the frequency of the detected radiation, the photoelectric conversion element reset transistor initializes the amount of electrical charge before the generated voltage is initialized.

9. The radiation detection apparatus according to claim 8, wherein when the frequency of the detected radiation is more than the predetermined frequency, the transfer transistor transfers the accumulated electric charge from the photoelectric conversion element to the floating diffusion region during an exposure time, wherein the exposure time is shorter than a time required to convert the voltage into a digital signal, and when the predetermined frequency is more than the frequency of the detected radiation, the transfer transistor transfers the accumulated electric charge from the photoelectric conversion element to the floating diffusion region during an exposure time, wherein the exposure time is longer than a time required to convert the voltage into a digital signal.

10. A control method for an image-capturing device, comprising:
initializing a voltage generated by a floating diffusion region, wherein the floating diffusion region is configured to generate the voltage according to an amount of electrical charge transferred from a photoelectric conversion element configured to convert light into the electrical charge and accumulate the electrical charge;
converting the voltage into a digital signal;
causing a photoelectric conversion element reset transistor to initialize the amount of electrical charge accumulated in the photoelectric conversion element; and
transferring the accumulated electric charge from the photoelectric conversion element to the floating diffusion region during an exposure time, wherein a start of the exposure time corresponds to a transition of the photoelectric conversion element reset transistor from a first state to a second state.

11. The control method according to claim 10, further including a pixel array unit including a plurality of pixels divided into a plurality of areas, the method further comprising:
initializing the generated voltage,
converting the generated voltage into a digital signal, and
outputting the converted digital signal for each area of the plurality of the areas.

12. The control method according to claim 11, further comprising:
holding, as a held noise component, a digital signal converted from the initialized voltage;
eliminating the held noise component from the digital signal converted from the generated voltage;
initializing the amount of electrical charge in at least one area of the plurality of areas;
transferring the initialized amount of electrical charge in at least one area of the plurality of areas; and
converting each of the initialized voltage and the generated voltage when the transfer of the accumulated electric charge from the photoelectric conversion element to the floating diffusion is performed.

13. The control method according to claim 11, further comprising:
holding a digital signal converted from the initialized voltage as a held noise component for one or more of the areas; and
eliminating the held noise component from the digital signal converted from the generated voltage when the transfer of the accumulated electric charge from the photoelectric conversion element to the floating diffusion is performed, wherein the photoelectric conversion element reset transistor initializes the amount of electrical charge for one or more of the areas, and
the transfer transistor performs the transfer of the accumulated electric charge from the photoelectric conversion element to the floating diffusion for one or more of the areas.

14. The control method according to claim 10, further comprising:
stacking a pixel arrangement substrate on a conversion unit arrangement substrate, wherein the pixel arrangement substrate includes the photoelectric conversion element, the floating diffusion region reset transistor, the photoelectric conversion element reset transistor, and the transfer transistor, and the conversion unit arrangement substrate includes the conversion unit.

15. A control method for a radiation detection apparatus, comprising:
initializing a voltage generated by a floating diffusion region, wherein the floating diffusion region is configured to generate a voltage according to an amount of electrical charge transferred from a photoelectric conversion element configured to convert light into the electrical charge and accumulate the electrical charge;
converting the voltage into a digital signal;
causing a photoelectric conversion element reset transistor to initialize the amount of electrical charge accumulated in the photoelectric conversion element;
transferring the accumulated electric charge from the photoelectric conversion element to the floating diffusion region during an exposure time, wherein a start of the exposure time corresponds to a transition of the photoelectric conversion element reset transistor from a first state to a second state; and
detecting whether radiation has entered within the exposure time based on a digital signal from which noise has been eliminated.

16. The control method according to claim 15, further including a pixel array unit including a plurality of pixels divided into a plurality of areas, the method further comprising:
initializing the generated voltage;
converting the generated voltage into a digital signal; and
outputting the converted digital signal for each area of the plurality of the areas.

17. The control method according to 15, further comprising:
deriving a frequency of the detected radiation based on a number of detections of radiation within a certain period of time, and
when the frequency of the detected radiation is more than a predetermined frequency, initializing the amount of electrical charge after the generated voltage is initialized, and
when the predetermined frequency is more than the frequency of the detected radiation, initializing the amount of electrical charge before the generated voltage is initialized.

18. The control method according to claim 17, further comprising:
transferring the accumulated electric charge from the photoelectric conversion element to the floating diffusion region during an exposure time when the frequency of the detected radiation is more than the predetermined frequency, wherein the exposure time is shorter than a time required to convert the voltage into a digital signal, and
transferring the accumulated electric charge from the photoelectric conversion element to the floating diffusion region during an exposure time when the predetermined frequency is more than the frequency of the detected radiation, wherein the exposure time is longer than a time required to convert the voltage into a digital signal.
